(19) United States
(12) Patent Application Publication
(10) Pub. No.: US 2003/0001519 A1
(43) Pub. Date: Jan. 2, 2003

(54) Integrated high brightness electrodeless lamp

(76) Inventors: Douglas A. Kirkpatrick, Great Falls, VA (US); Gary K. Bass, Mt. Airy, MD (US); Jesse F. Copsey, Germantown, MD (US); Aleksandr Gitsevich, Montgomery Village, MD (US); David Helsel, Gaithersburg, MD (US); David W. Lawrence, Clarksville, MD (US); Edward P. Rhyne, Columbia, MD (US); Stephen J. Sweeney, Sykesville, MD (US); Peter Tsai, Olney, MD (US)

Correspondence Address: FUSION LIGHTING INC, PAUL E STEINER, 7524 STANDISH PLACE, ROCKVILLE, MD, 20855

(21) Appl. No.: 10/156,689

(22) Filed: May 29, 2002

Related U.S. Application Data
(60) Provisional application No. 60/293,531, filed on May 29, 2001.
(60) Provisional application No. 60/315,030, filed on Aug. 28, 2001.

(51) Int. Cl. H05B 41/16

(52) U.S. Cl. 315/248

(57) ABSTRACT

An integrated high brightness electrodeless lamp includes a lamp base defining two or more compartments housing components of the lamp, wherein at least one compartment provides an opening in the lamp base, a cover fitted to the lamp base, and an optics assembly positioned in the opening in the lamp base, wherein the lamp base, the cover, and the optics assembly provide an RF sealed system. The lamp components include an RF source providing RF energy for the lamp, an aperture bulb assembly including an electrodeless envelope containing a discharge forming fill which emits light when excited by RF energy, and an excitation structure for coupling RF energy from the RF source to the discharge forming fill. The optics assembly may be mounted in the opening in the lamp base with a twist lock mounting structure.

### CROSS REFERENCE TO RELATED APPLICATIONS

The present application is based on and claims priority to U.S. Provisional Patent Application Nos. 60/293,531, filed May 29, 2001 and 60/315,030, filed Aug. 28, 2001.

Certain inventions described herein were made with government support under Contract No. NAS10-99037 awarded by the National Aeronautics and Space Administration. The government has certain rights in those inventions.

### BACKGROUND

1. Field of the Invention

The invention relates generally to electrodeless lamps and more specifically to an integrated high brightness electrodeless lamp.

2. Related Art

The electrodeless lamps described herein are improvements and/or modifications of the lamps described in U.S. Pat. Nos. 6,137,237, 6,313,587, and PCT Publication No. WO 01/03161, both of which include some examples of integrated electrodeless lamps and both of which are incorporated herein by reference in their entirety.

### SUMMARY

The following and other objects, aspects, advantages, and/or features of the invention described herein are achieved individually and in combination. The invention should not be construed as requiring two or more of such features unless expressly recited in a particular claim.

One object of the invention is to provide an integrated high brightness electrodeless lamp. An aspect of the invention involves simplified manufacture and/or assembly of such a lamp. Another aspect involves improved RF shielding of such a lamp.

One aspect of the present invention is a power oscillator operating at frequencies above 500 MHz and utilizing a multi-die transistor package with all die attached to a single leadframe.

Another aspect of the present invention is a complementary varactor diode tuning circuit for an electronically tunable power oscillator.

Another aspect of the present invention is a novel three stage tuning algorithm for a power oscillator. Another aspect of the present invention involves tuning for increased forward power.

Another aspect of the present invention is an aperture cup having a thinned plate defining the aperture.

Another aspect of the present invention is an aperture cup providing a thermal path through the cup neck.

Another aspect of the present invention is the thermal management of the aperture cup from the back of the cup.

Another aspect of the present invention is a small ceramic sliver positioned in the throat of the wedding ring coil.

Another aspect of the present invention is a novel optics holder for holding a hollow CPC.

Another aspect of the present invention is a lamp housing with an exterior surface adapted to mate with a folded fin heatsink.

Another aspect of the present invention is a combination digital and analog tuning circuit for a power oscillator.

Another aspect of the present invention is an optical element comprising serial CPC with no intermediate integrator.

Another aspect of the present invention is a ceramic encased excitation coil made from LTCC processes.

Another aspect of the present invention is an optics independent design of the lamp housing. Another aspect of the invention is a screw lock mechanism for the optics holder. Another aspect of the invention is a conductive RF screen positioned between the lamp housing and an optics tube.

### BRIEF DESCRIPTION OF THE DRAWINGS

The foregoing and other objects, features, and advantages of the invention will be apparent from the following more particular description of preferred embodiments as illustrated in the accompanying drawings, in which reference characters generally refer to the same parts throughout the various views. The drawings are not necessarily to scale, the emphasis instead being placed upon illustrating the principles of the invention.

FIG. 1 is a perspective view of a lamp system.

FIG. 2 is a front, schematic view of the lamp system from FIG. 1.

FIG. 3 is a cross sectional, schematic view taken along line 3-3 in FIG. 1.

FIG. 4 is an exploded perspective view of the lamp system from FIG. 1.

FIG. 5 is a top, schematic view of the housing in the lamp system from FIG. 1.

FIG. 6 is a front, schematic view of the housing.

FIG. 7 is an enlarged, fragmented view of the area 7 in FIG. 6.

FIG. 8 is a perspective view of the housing.

FIG. 9 is an enlarged, fragmented view of the area 9 in FIG. 8.

FIG. 10 is a top, schematic view of a heatsink.

FIG. 11 is a perspective view of the heatsink.

FIG. 12 is a perspective view of the heatsink from another angle.

FIG. 13 is a perspective view of a fan enclosure.

FIG. 14 is a perspective view of the lamp system from FIG. 1 together with the heatsink from FIG. 11 and the fan enclosure from FIG. 13.

FIG. 15 is a perspective view of another lamp housing.

FIG. 16 is a front, schematic view of the housing from FIG. 15.

FIG. 17 is a cross sectional, schematic view taken along line 17-17 in FIG. 16.

FIG. 18 is a cross sectional, perspective view of another lamp system.

FIG. 19 is a top, cross sectional schematic view of the housing for the lamp system in FIG. 18.

FIG. 20 is a perspective view of another lamp housing.

FIG. 21 is an exploded, perspective view of the housing from FIG. 20.

FIG. 22 is a bottom, schematic view of the housing from FIG. 20.

FIG. 23 is a cross sectional, schematic view taken along line 23-23 in FIG. 22.

FIG. 24 is a perspective view of another lamp housing.

FIG. 25 is an exploded, perspective view of the housing from FIG. 24.

FIG. 26 is a bottom, schematic view of the housing from FIG. 24.

FIG. 27 is a cross sectional, schematic view taken along line 27-27 in FIG. 26.

FIG. 28 is an exploded, perspective view of another lamp system.

FIG. 29 is a front, schematic view of the housing in the lamp system of FIG. 28.

FIG. 30 is a partial cross sectional, schematic view taken along line 30-30 in FIG. 29.

FIG. 31 is a fragmented, perspective view of another lamp system.

FIG. 32 is an exploded, perspective view of the lamp system from FIG. 32.

FIG. 33 is an exploded, perspective view of another lamp system.

FIG. 34 is a perspective view of an optics holder together with an aperture bulb.

FIG. 35 is a schematic view of the optics holder and aperture bulb in FIG. 34.

FIG. 36 is a cross sectional, schematic view taken along line 36-36 in FIG. 35.

FIG. 37 is a perspective view of another optics holder.

FIG. 38 is a front, schematic view of the optics holder in FIG. 37.

FIG. 39 is a top schematic view of the optics holder in FIG. 37.

FIG. 40 is a cross sectional, schematic view taken along line 40-40 in FIG. 39.

FIG. 41 is a perspective view of another optics holder.

FIG. 42 is a front, schematic view of the optics holder in FIG. 41.

FIG. 43 is a top schematic view of the optics holder in FIG. 41.

FIG. 44 is a cross sectional, schematic view taken along line 44-44 in FIG. 43.

FIG. 45 is a fragmented, perspective view of another lamp system.

FIG. 46 is a perspective view of another optics holder together with an aperture bulb.

FIG. 47 is a schematic view of the optics holder and aperture bulb in FIG. 46.

FIG. 48 is a cross sectional, schematic view taken along line 48-48 in FIG. 47.

FIG. 49 is a perspective view of another optics holder together with an aperture bulb.

FIG. 50 is a schematic view of the optics holder and aperture bulb in FIG. 49.

FIG. 51 is a cross sectional, schematic view taken along line 51-51 in FIG. 50.

FIG. 52 is a perspective view of another optics holder.

FIG. 53 is a schematic view of the optics holder in FIG. 52.

FIG. 54 is a cross sectional, schematic view taken along line 54-54 in FIG. 53.

FIG. 55 is a perspective view of an aperture cup.

FIG. 56 is a schematic view of the aperture cup in FIG. 55.

FIG. 57 is a cross sectional, schematic view taken along line 57-57 in FIG. 56.

FIG. 58 is a perspective view of another aperture cup.

FIG. 59 is a schematic view of the aperture cup in FIG. 58.

FIG. 60 is a cross sectional, schematic view taken along line 60-60 in FIG. 59.

FIG. 61 is a perspective view of another aperture cup.

FIG. 62 is a schematic view of the aperture cup in FIG. 61.

FIG. 63 is a cross sectional, schematic view taken along line 63-63 in FIG. 62.

FIG. 64 is a perspective view of another lamp system.

FIG. 65 is a front, schematic view of the lamp from FIG. 64.

FIG. 66 is a cross sectional, schematic view taken along line 66-66 in FIG. 65.

FIG. 67 is an exploded, perspective view of the lamp from FIG. 64.

FIG. 68 is a back, schematic view of the lamp from FIG. 64.

FIG. 69 is a perspective view of the base for the lamp from FIG. 64.

FIG. 70 is a top, schematic view of the base from FIG. 69.

FIG. 71 is a front, schematic view of the base from FIG. 69.

FIG. 72 is a perspective view of another lamp system.

FIG. 73 is a perspective view of the lamp system from FIG. 72 with the cover removed.

FIG. 74 is a front, schematic view of the lamp system from FIG. 72.

FIG. 75 is a back, schematic view of the lamp system from FIG. 72.

FIG. 76 is a top, schematic view of the lamp system from FIG. 72.

FIG. 77 is an exploded perspective view of the lamp system from FIG. 72, together with an example set of optical components.

FIG. 78 is a cross sectional, schematic view taken along line 78-78 in FIG. 76, together with the example set of optical components.

FIG. 79 is a cross sectional, schematic view taken along line 79-79 in FIG. 76.

FIG. 80 is a perspective view of the lamp base.

FIG. 81 is a front, schematic view of the lamp base.

FIG. 82 is a top, schematic view of the lamp base.

FIG. 83 is an exploded perspective view of the RF source assembly.

FIG. 84 is a schematic view of the capacitor stack dielectric.

FIG. 85 is a schematic view of the coil form.

FIG. 86 is a schematic diagram of the power oscillator.

FIG. 87 is a schematic diagram of a varactor tuning circuit for the RF source.

FIG. 88 is a schematic circuit diagram of the printed circuit board layout of the RF source.

FIG. 89 is an assembly drawing of the RF source.

FIG. 90 is a schematic circuit diagram of a multi-die transistor package.

FIG. 91 is a schematic circuit diagram of a multi-die transistor package according to an aspect of the present invention.

FIG. 92 is a perspective view of a multi-die package according to an aspect of the present invention.

FIG. 93 is a top, perspective view of the coil heatsink.

FIG. 94 is a bottom, perspective view of the coil heatsink.

FIG. 95 is a top, schematic view of the coil heatsink.

FIG. 96 is a cross section view taken along line 96-96 in FIG. 95.

FIG. 97 is a perspective view of the tuning bridge.

FIG. 98 is a top, schematic view of the tuning bridge.

FIG. 99 is a front, schematic view of the tuning bridge.

FIG. 100 is a perspective view of the tuning block.

FIG. 101 is a top, schematic view of the tuning block.

FIG. 102 is a front, schematic view of the tuning block.

FIG. 103 is a perspective view of the aperture cup.

FIG. 104 is a top schematic view of the aperture cup.

FIG. 105 is a front, schematic view of the first aperture cup.

FIG. 106 is a cross sectional view taken along line 106-106 in FIG. 105.

FIG. 107 is an enlarged detail view of the area 107 in FIG. 106.

FIG. 108 is a perspective view of the bottom side cup heatsink.

FIG. 109 is a side, schematic view of the cup heatsink.

FIG. 110 is a top, schematic view of the cup heatsink.

FIGS. 111-112 are a schematic diagram of the RF control circuit.

FIG. 113 is a fragmented, cross section view of a lamp base and folded fin heatsink.

FIG. 114 is a fragmented, cross section view of another lamp base and folded fin heatsink.

FIG. 115 is a schematic, cross sectional view of a back cooled aperture lamp.

FIG. 116 is a schematic, cross sectional view of an optics assembly including a hollow CPC and novel retainer ring for holding the hollow CPC.

FIG. 117 is a schematic, cross sectional view of a lamp system utilizing serial CPCs.

FIG. 118 is a schematic, cross sectional view of a monolithic aperture cup and optical element, namely a one-piece aperture cup and CPC.

FIG. 119 is an exploded perspective view of a lamp system with a conductive screen disposed between the lamp and an optics tube.

FIG. 120 is a back, schematic view of an optics tube assembly including a conductive RF screen.

FIG. 121 is a schematic view of the conductive RF screen.

FIG. 122 is a cross sectional view taken along line 122-122 in FIG. 120.

FIG. 123 is a schematic, cross sectional view of a low temperature co-fired ceramic (LTCC) structure.

FIG. 124 is a schematic, cross sectional view of the LTCC structure formed into a wedding ring shaped excitation coil.

### DESCRIPTION

In the following description, for purposes of explanation and not limitation, specific details are set forth such as particular structures, interfaces, techniques, etc. in order to provide a thorough understanding of the various aspects of the invention. However, it will be apparent to those skilled in the art having the benefit of the present disclosure that the various aspects of the invention may be practiced in other examples that depart from these specific details. In certain instances, descriptions of well known devices, circuits, and methods are omitted so as not to obscure the description of the present invention with unnecessary detail.

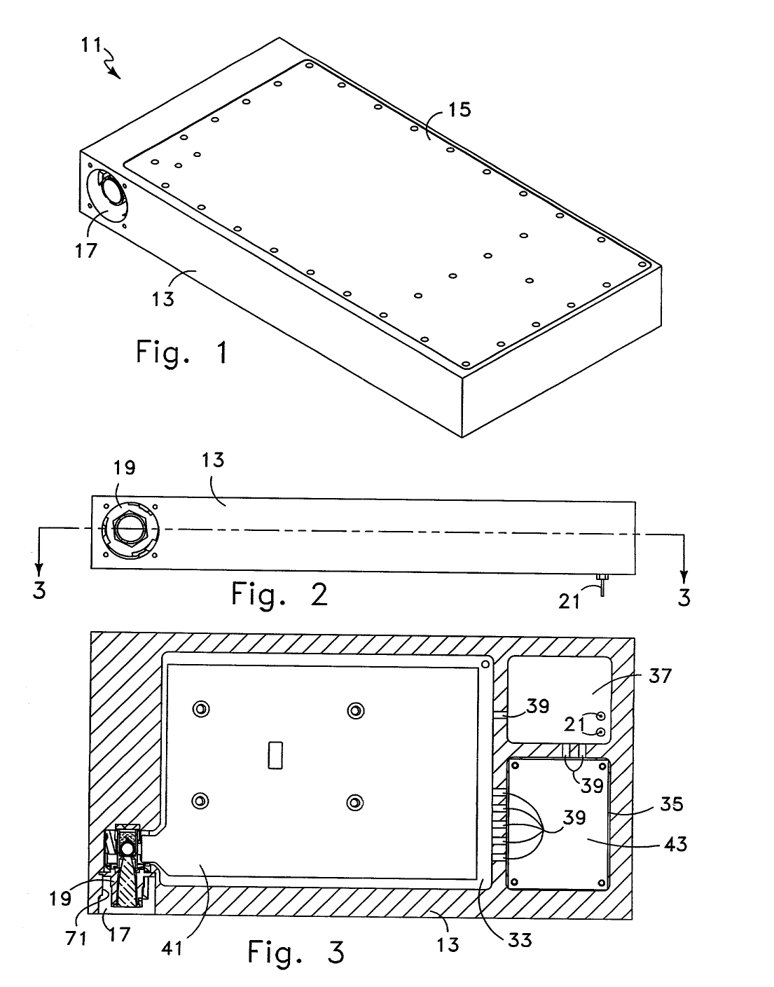

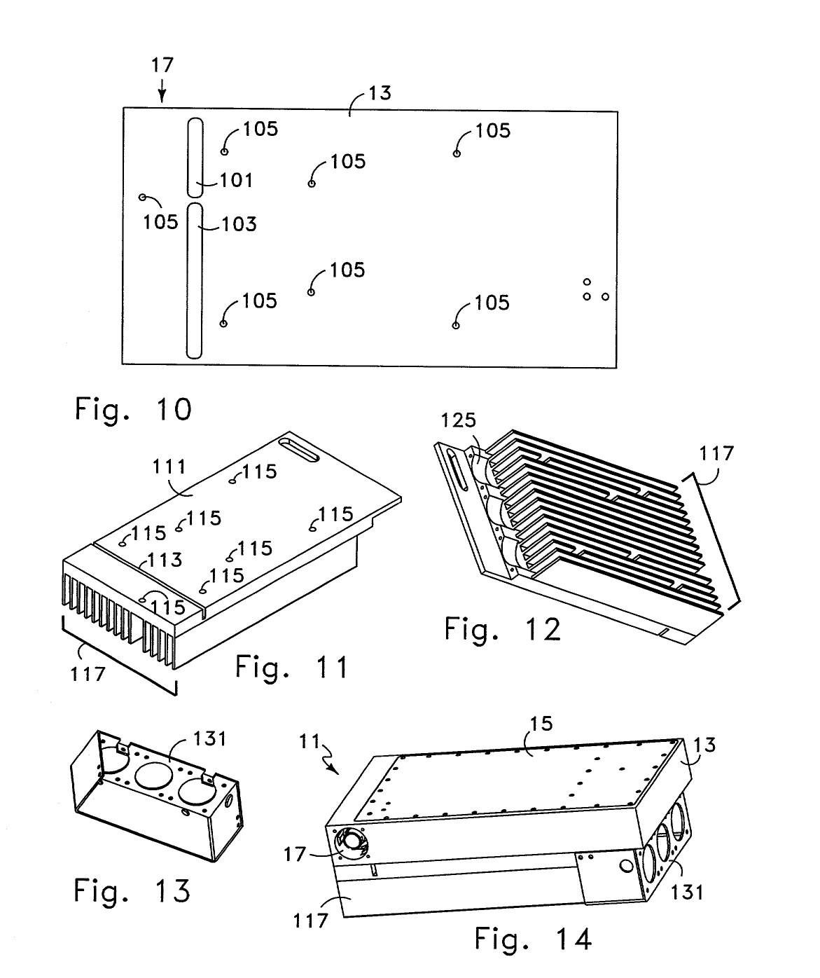

With reference to FIGS. 1-14, an integrated high brightness lamp 11 includes an housing 13 and a lid 15. The housing 13 defines an opening 17 through which light is emitted. The opening 17 is adapted to receive an optics assembly 19 and other lamp components.

The housing defines one or more internal compartments for mounting lamp components. In the illustrated example, three internal compartments 31, 33, and 35 are separated by walls. For example, the compartment 33 may contain an integrated RF board and lamp circuit 41, the compartment 35 may contain a control board 43, and the compartment 37 may contain power feedthrough pins 21 and other interface circuitry.

The lamp 11 is RF sealed to keep emissions below an acceptable level for interference. Components in the opening 17 define a choked down opening which is below cutoff for the operating frequency of the lamp 11. Small openings 39 may be provided between the various compartments. The openings 39 are also below cutoff to reduce RF emissions between the compartments. An RF gasket may be positioned between the lid 15 and the housing 13.

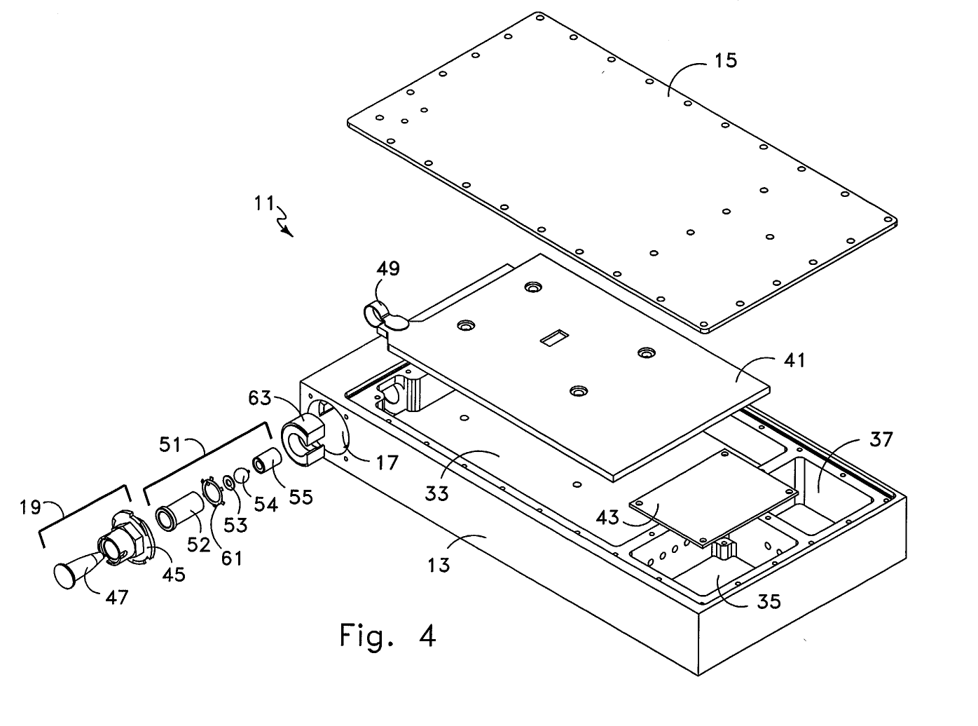

With reference to FIG. 4, the optics assembly 19 includes an optics holder 45 and an etendue conserving non-imaging optic, for example, a compound parabolic concentrator (CPC) 47. Advantageously, the optics assembly 19 is a separate modular part that can be manufactured by any of a number of processes (e.g. casting, machining, stamping, powdered metal technology, or cnc machining). Because the assembly 19 is a separate part, the optics can be adjusted or improved and retrofitted without requiring a redesign of the total lamp system.

The other components disposed in the opening 17 include an aperture bulb 51 comprised of a ceramic cup 52, a front aperture washer 53, a bulb 54, and a reflective ceramic material 55. A retaining ring 61 holds the aperture bulb 51 in place with the optics assembly 19. See FIG. 36 for a more detailed view of the assembled relationship. The integrated RF board and lamp circuit 41 includes an excitation coil 49 which is disposed in the opening 17. A ceramic heatsink 63 is positioned around the outside of the coil 49 for conducting heat from the coil 49 to the housing 13. The aperture bulb 19 is positioned inside the coil 49 with the bulb 54 roughly centered with respect to the coil 49.

The integrated RF board 41 and the control board 43 may be configured as described in the above mentioned '161 publication. In general, RF energy generated by the RF board 41 is transferred to the coil 49 which couples the energy to a fill in the bulb 54. The excited fill emits light which exits the aperture bulb 51 through the front aperture washer 53. The light from the aperture bulb 51 is collected by the CPC 47 and directed out through the opening 17. The light from the lamp 11 may be further acted on by external optics as may be necessary or desirable for a particular application. Other details regarding the construction and operation of suitable lamp components my be had with reference to the '237 patent and the '161 publication.

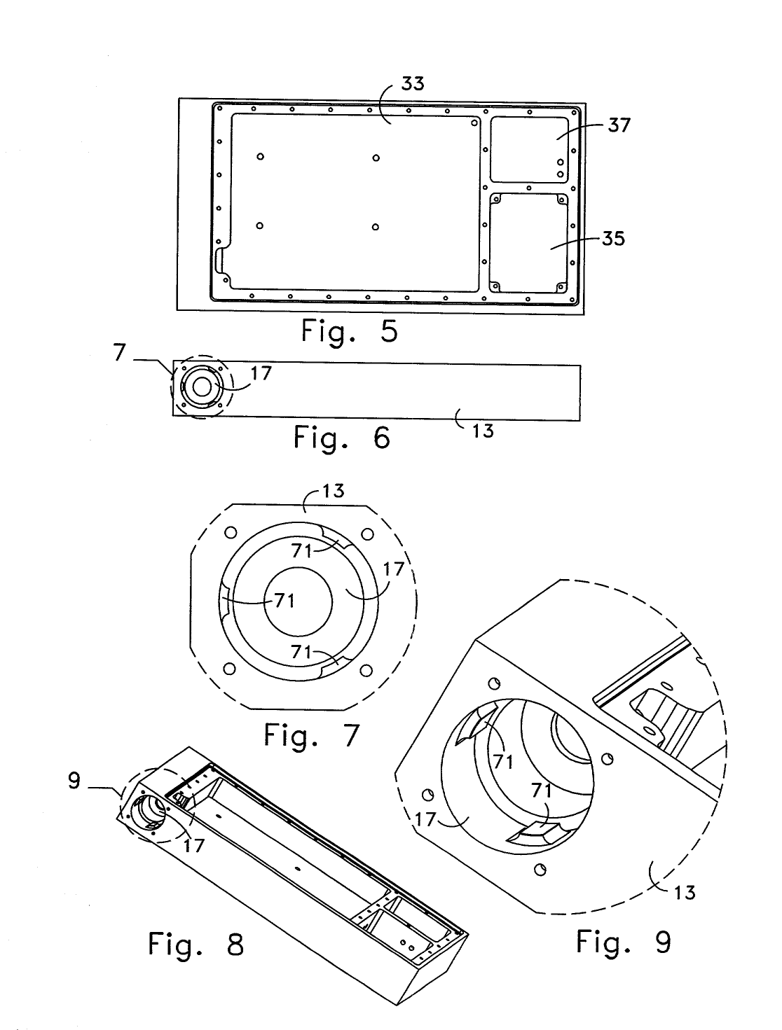

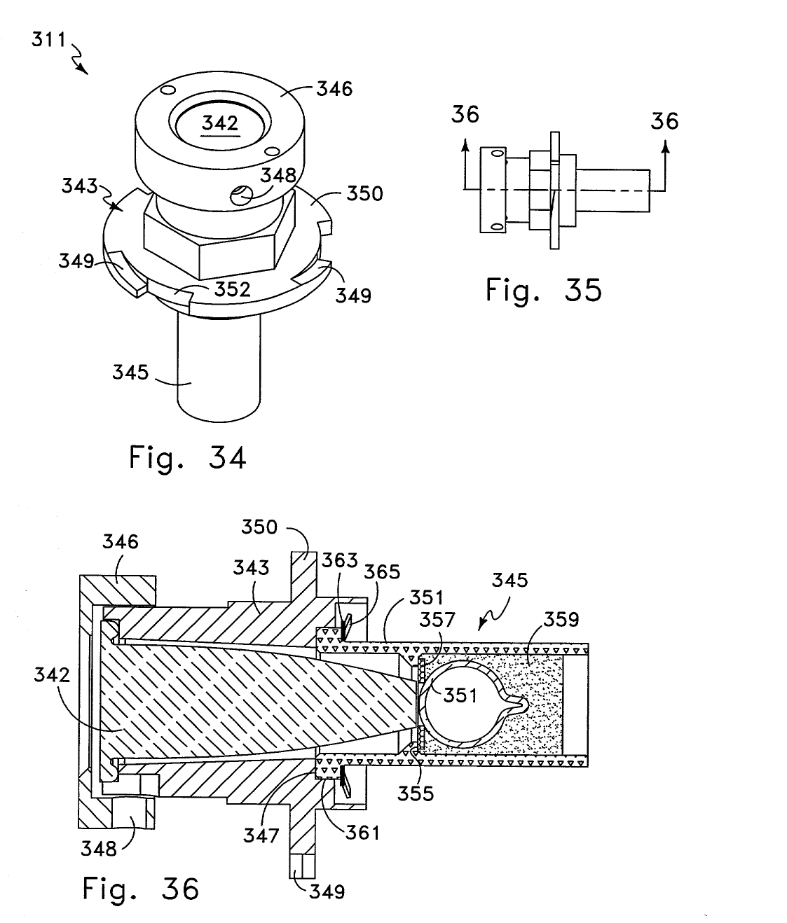

With reference to FIGS. 6-9, the housing 13 defines one or more raised ribs 71 in the are of the opening 17 which cooperate with the optics assembly 19 to secure the optics assembly 19 in the opening 17, as described in more detail in 26 connection with FIGS. 34-36.

With reference to FIGS. 10-14, a bottom side of the housing 13 defines two elongated slots 101 and 103 which act as thermal breaks between the lamp circuit and the RF circuit on the integrated RF board 41. A heatsink 111 defines a corresponding slot 113 on a top surface thereof which likewise acts as a thermal break between the heat generated by the bulb and the heat generated by the RF transistor. The housing 13 and the heatsink 111 defines a plurality of corresponding mounting holes 105, 115, respectively. The heatsink 111 has a plurality of heat dissipating fins 117. There may be breaks in the fins in the area of the mounting holes 115. For example, the holes 105 may be threaded and bolts may be used to hold the heatsink 111 in tight mechanical and thermal contact with the housing 13. A thermal gasket or thermal epoxy may be disposed between the heatsink 111 and the housing 13.

The heatsink 111 is adapted to mount one or more fans in the areas 125. A shroud 131 may be disposed around the fans (not shown) to direct the cooling air over the fins 117.

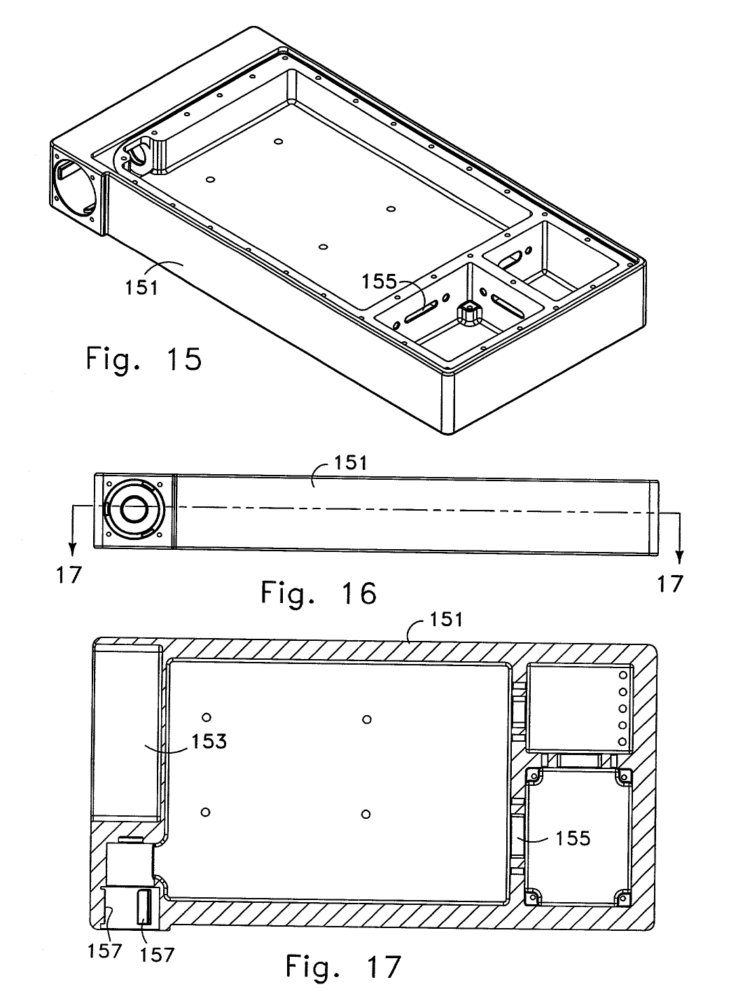

With reference to FIGS. 15-17, another example of a housing 151 includes a hollowed out space 153 behind the lamp components. The openings between the various compartments includes elongated slots 155. The cross sectional view in FIG. 17 shows the raised ribs 157.

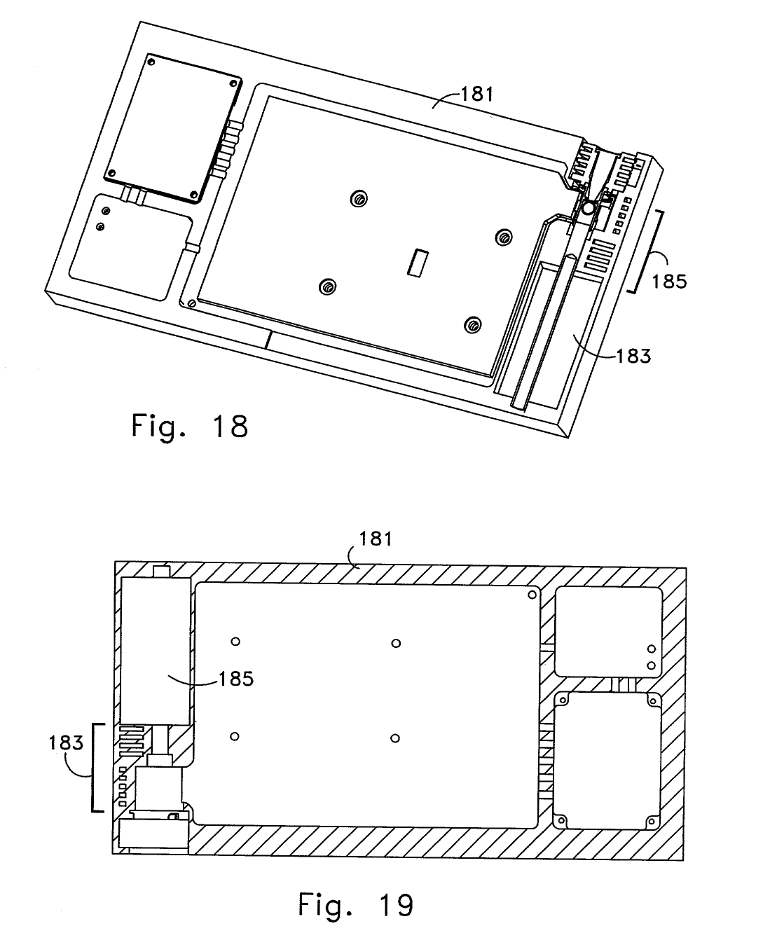

With reference to FIG. 18-19, another example of a housing 181 includes a hollowed out space 183 behind the lamp components and a plurality of slots 185 in the housing 181 near the aperture bulb. The space 183 and the slots 185 reduce the weight of the housing 181. The slots 185 also increase the surface area for better heat dissipation.

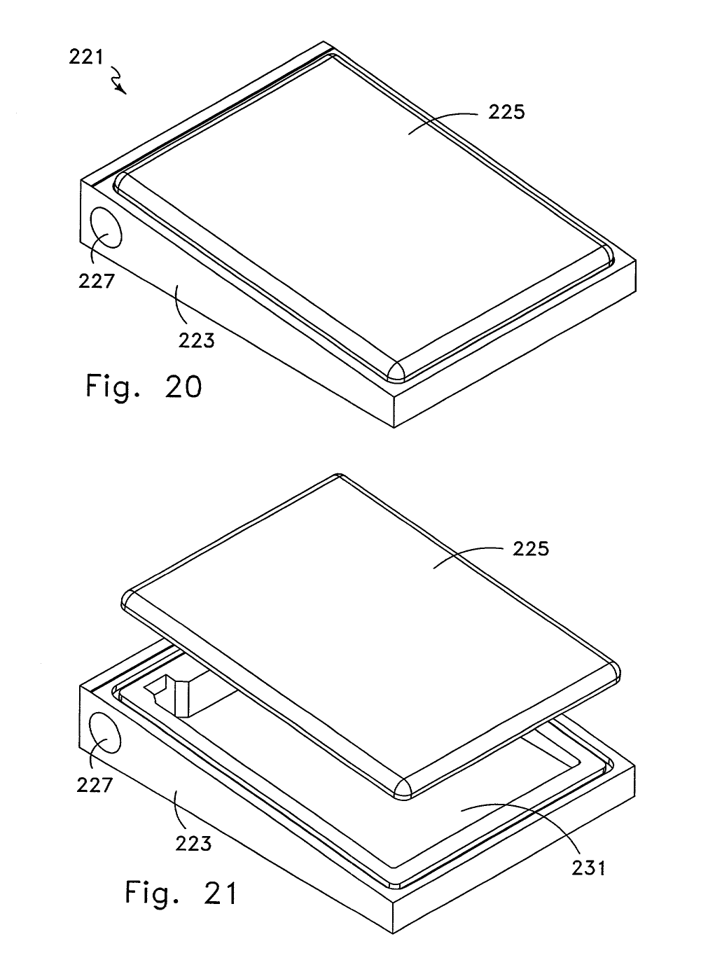

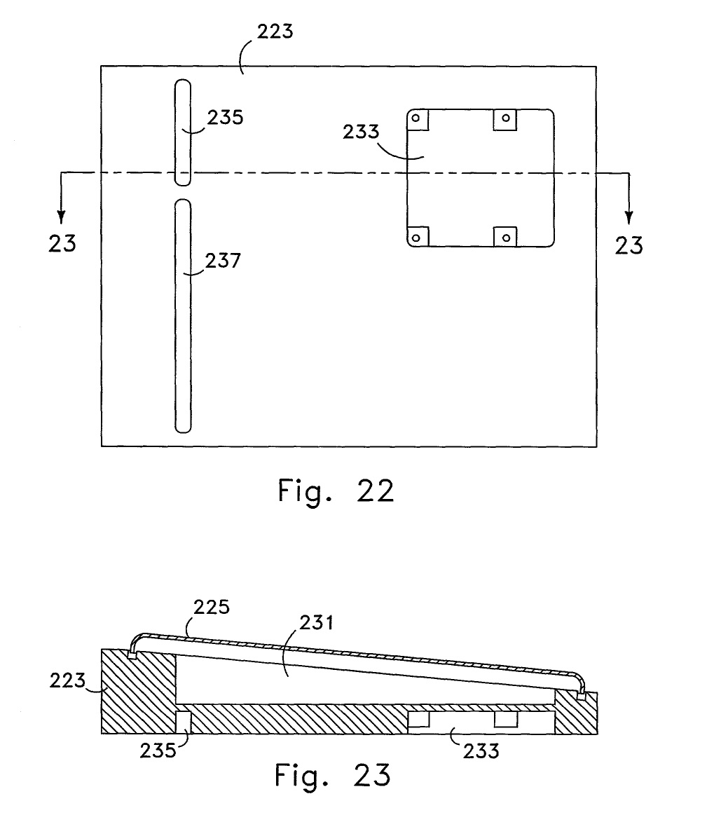

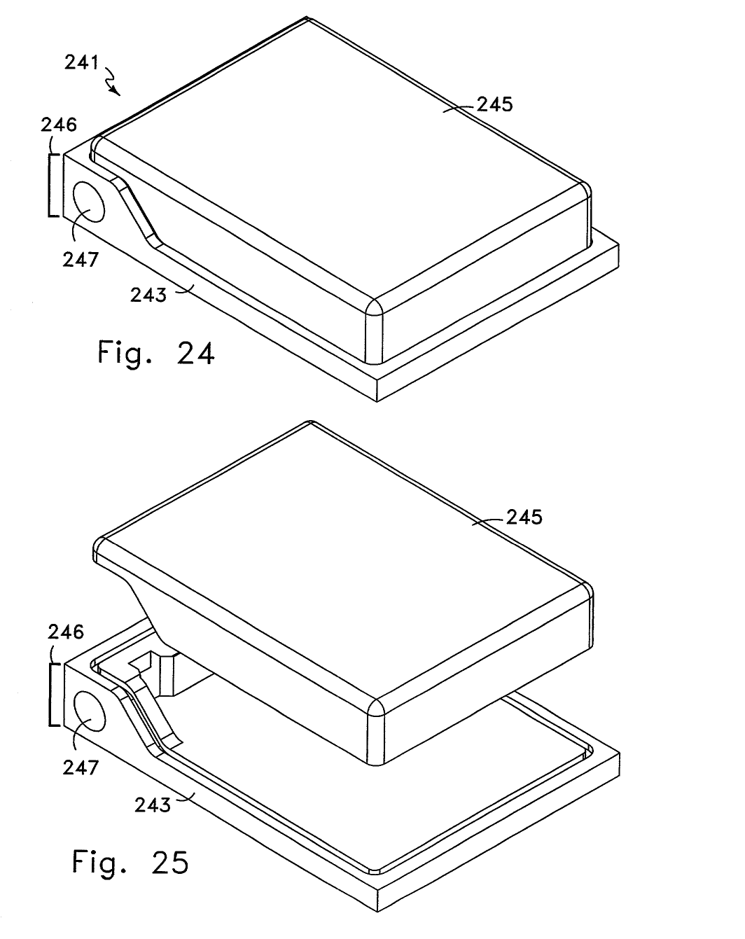

With reference to FIGS. 20-23, another example of a lamp 221 includes a wedge shaped housing 223 and a cover 225. The housing 223 defines an opening 227 through which light is emitted. In addition to the compartment for the bulb and optics components, the housing 223 defines one internal compartment 231 and one external compartment 233.

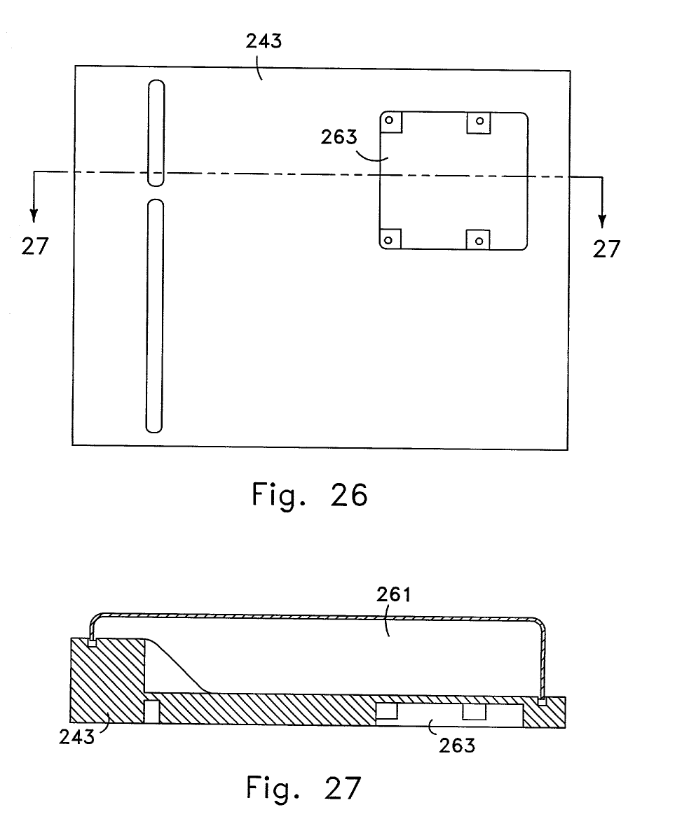

With reference to FIGS. 24-27, another example of a lamp 241 includes a base 243 and a cover 245. The base 243 is substantially flat except for a raised portion 246 that defines the compartment for the bulb and optics components. The raised portion 246 also defines the light emitting opening 247. The base 243 and cover 245 together define one internal compartment 261. The base 243 further defines one external compartment 263.

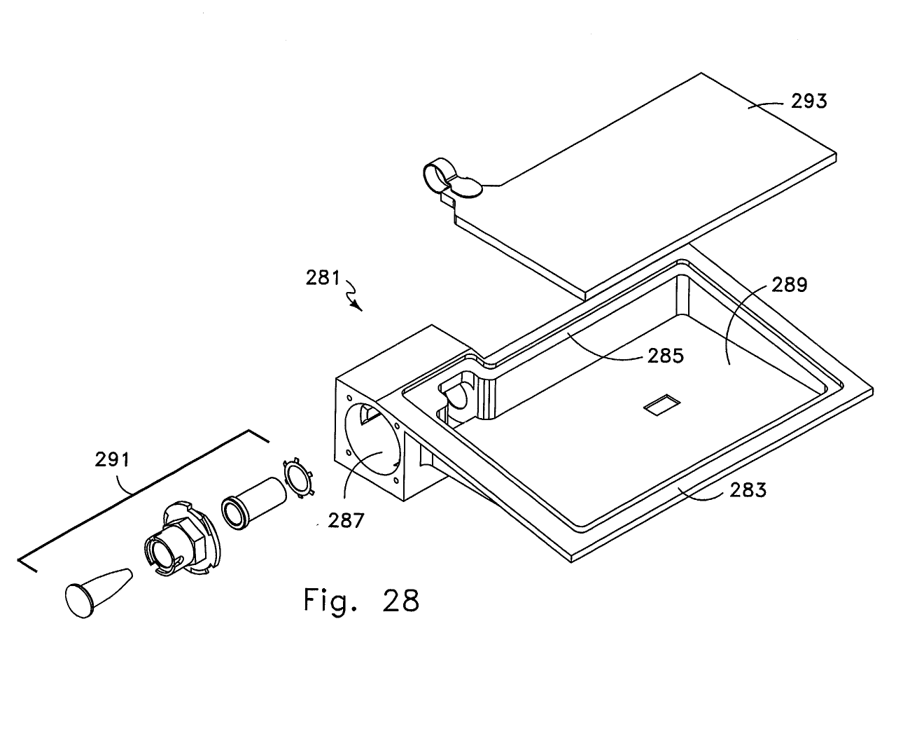

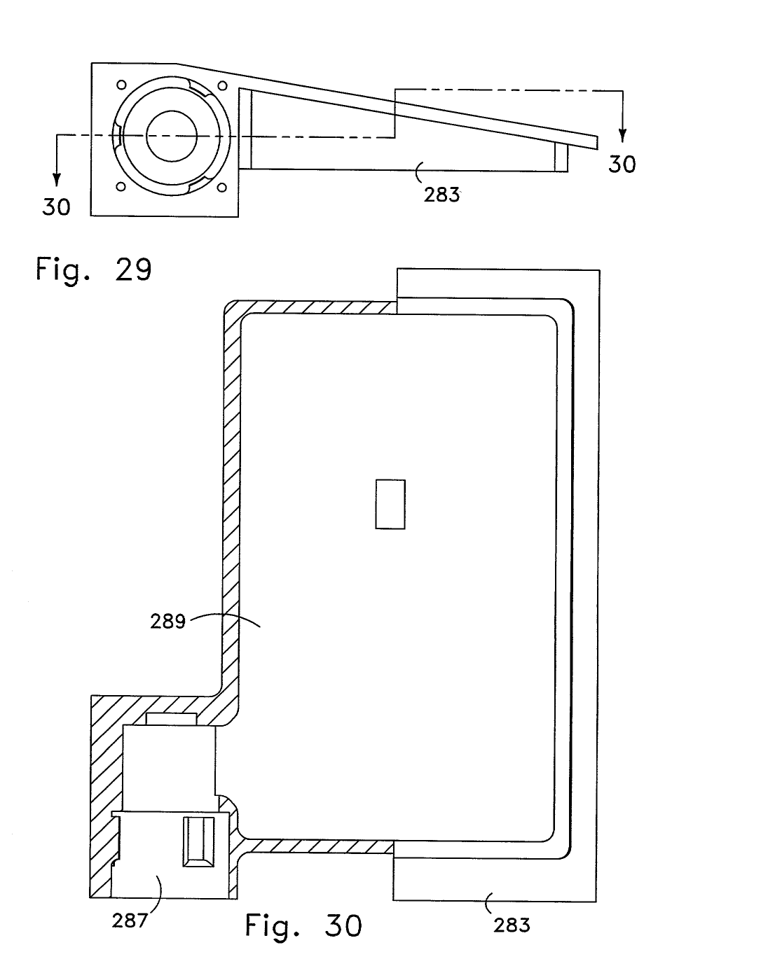

With reference to FIGS. 28-30, another example of a lamp 281 includes a wedge shaped housing 283. A lid (not shown) fits on the raised ridge 285 defined by the housing 283. The housing defines one compartment 287 for receiving the bulb and optics components 291 and one compartment 289 for receiving other lamp components such as the RF board 293 (and optionally the control board, not shown).

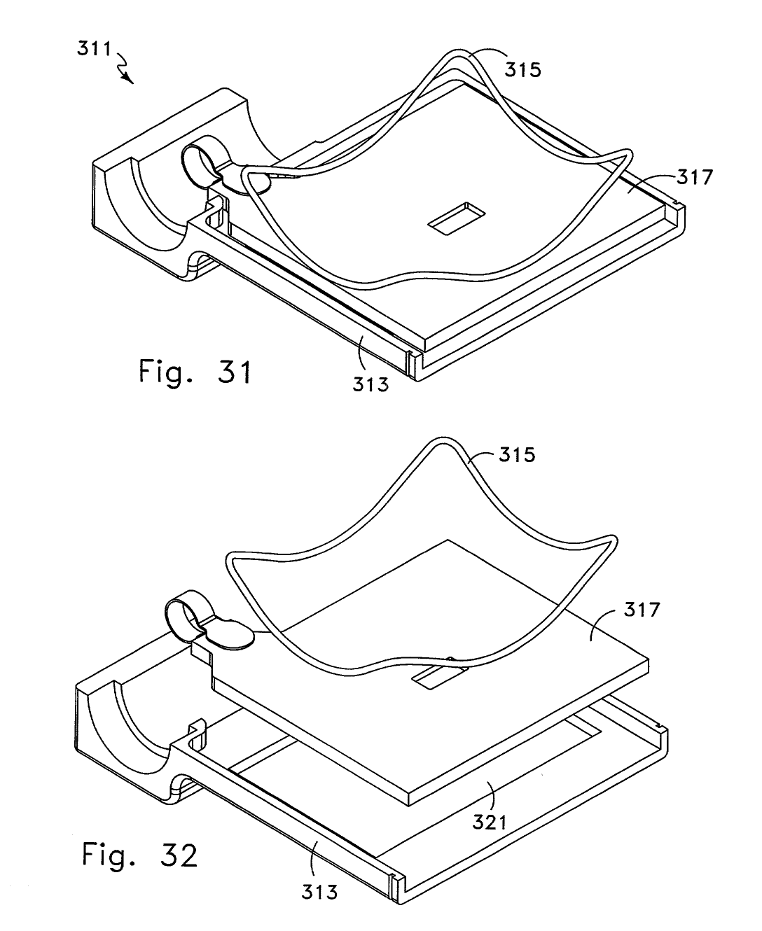

With reference to FIGS. 31-32, another example of a lamp 311 includes a housing 313 and a cover (not shown). A resilient bail 315 is positioned between the lid and the RF board 317. The housing 313 is partially open in the area 321 behind the RF board 317 to allow direct access to the RF board 317 for thermal management.

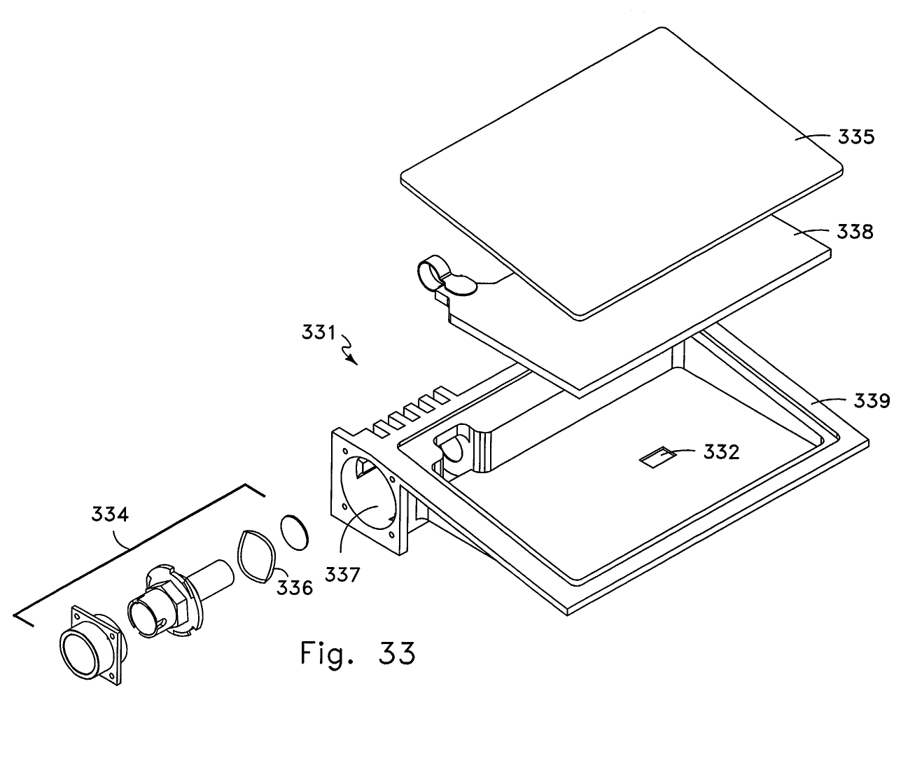

With reference to FIG. 33, another example of a lamp 331 includes a wedge shaped housing 333 and a lid 335. The housing 333 defines one compartment 337 for the bulb and optics 334 and another compartment 339 for the integrated RF board 338. The lamp 331 includes a spring 339 for tensioning the optics holder in place.

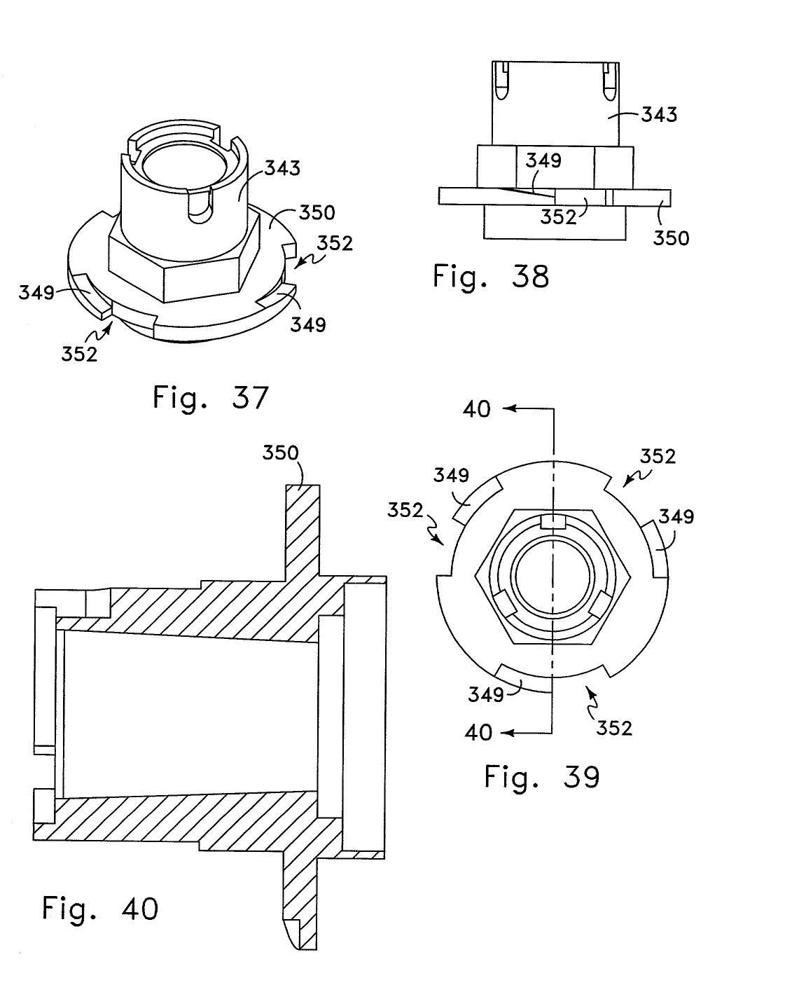

With reference to FIGS. 34-40, an optics and bulb assembly 341 includes an optics holder 343 and an aperture bulb 345. Advantageously, by mounting the aperture bulb 345 with the optics holder 343, optical alignment is more readily achieved. Alignment of the bulb with respect to the coil is less critical and may be provided with sufficient accuracy by the combined bulb and optics assembly.

The aperture bulb 345 includes a ceramic cup 351 with a bulb 353 disposed therein. The cup 351 defines an internal shoulder 355. A ceramic washer 357 is positioned against the shoulder 355 and the bulb 353 is positioned against the washer 357. The washer 357 defines an aperture for light emitted from the bulb 353. The bulb 353 is covered with reflective ceramic material 359. The cup further defines a flange 361. The optics holder 343 has a central bore which is counter-bored at one end to define a shoulder 347 adapted to receive the flange 361. A retaining ring 363 has an inner diameter which is closely matched to an outer diameter of the cup 351. The retaining ring 363 is received inside the optics holder 343 and has resilient tabs 365 which contact inside walls of the holder 343 and lock the cup 351 in position against the holder 343.

The holder is adapted to receive a CPC 342 which may be held in place with a cover 346 and a set screw (not shown) through a hole 348 in the cover 346. The holder 343 is adapted with one or more wedge shaped ridges which are adapted to cooperate with the raised ribs in the lamp housing opening to secure the optics and bulb assembly in place. The ridges are defined on a flange 350 around the optics holder 343. The flange defines a set of gaps 352 which correspond to the location of the ribs. During assembly, the gaps (which may or may not be keyed) are aligned with the ribs and the optics holder is slid into the opening until it stops against a shoulder in the housing. The optics holder is then twisted (counter-clockwise for the illustrated example) until the ridges 346 have a firm friction fit with the bottom of the raised ribs. In this manner, the optics holder has a simple twist-lock assembly with the housing.

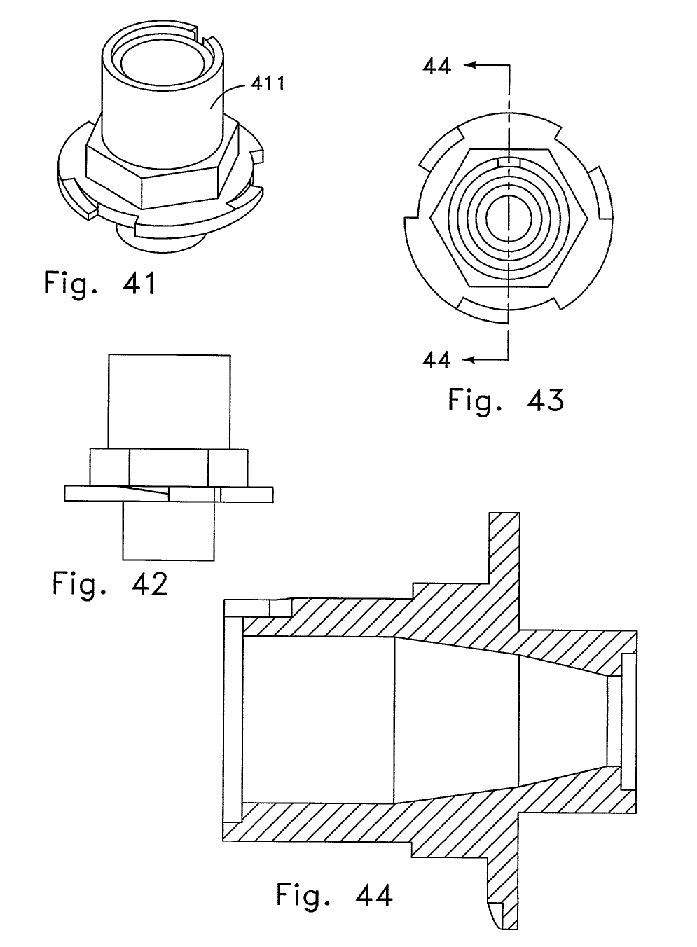

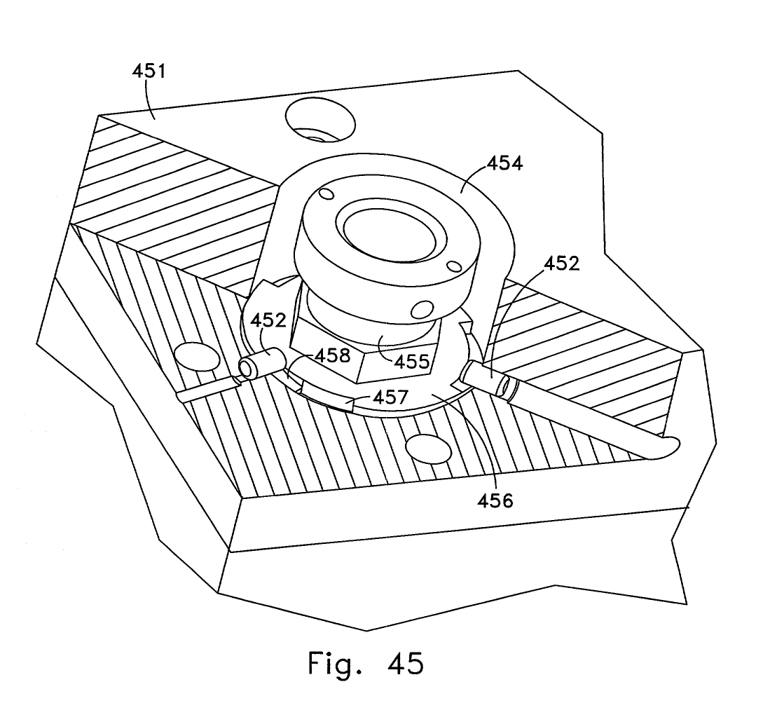

With reference to FIGS. 41-44, another example of an optics holder 411 with a twist lock assembly is shown.

With reference to FIG. 45, an alternative to the raised ribs is shown in a cut away view. A lamp housing 451 includes one or more pins 452 disposed in the side wall of an opening 454 in the housing 451. An optics holder 455 is configured as described in the above examples with a flange 456 defining gaps 457 corresponding to the pin locations and wedge shaped ridges 458 adjacent to the gaps. A twist-lock assembly procedure is utilized to secure the bulb and optics to the housing.

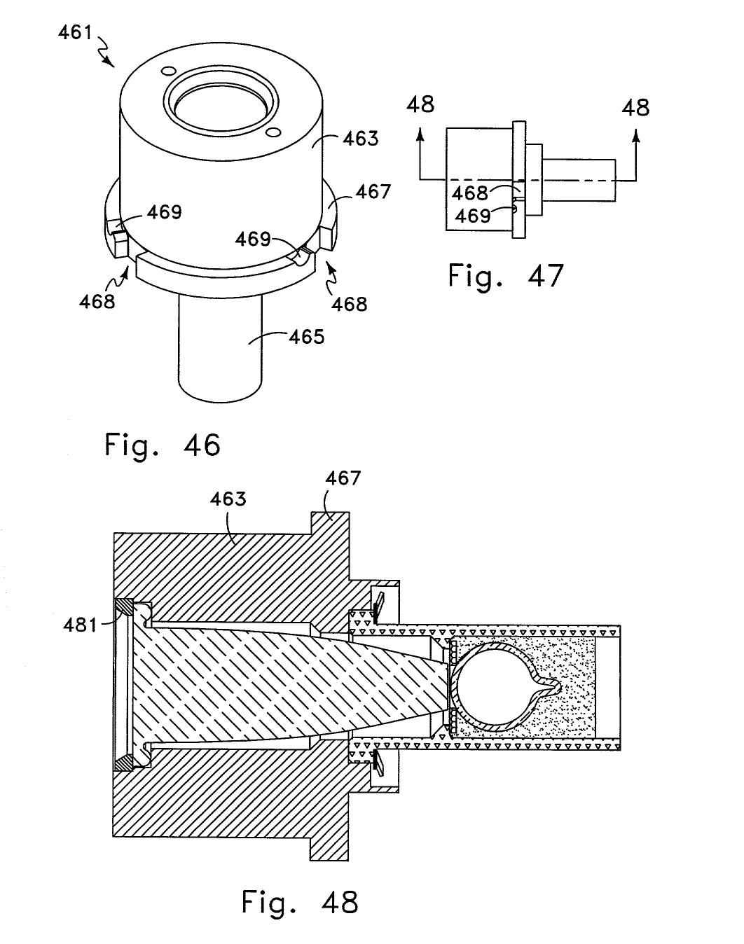

With reference to FIGS. 46-48, another example of a bulb and optics assembly 461 includes an optics holder 463 and an aperture bulb 465. The optics holder 463 includes a flange 467 with defines one or more gaps 468 and indents 469. For example, the assembly 461 may be secured to a housing utilizing pins (e.g. see FIG. 45) with a twist-lock assembly procedure. The holder 463 is adapted to use a threaded retaining ring 481 to hold the CPC in place.

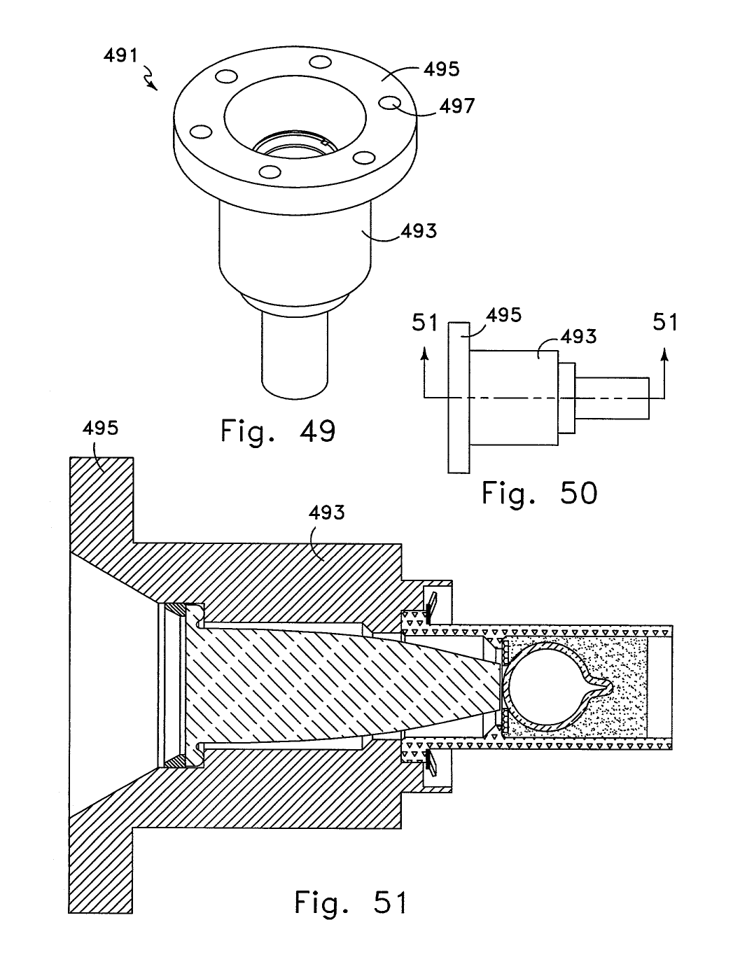

With reference to FIGS. 49-51, another example of a bulb and optics assembly 491 includes an optics holder 493 with a front flange 495 having a plurality of mounting holes 497 positioned around the flange. The assembly 491 is secured to the housing by a plurality of fasteners (e.g. bolts) through corresponding mounting holes on the housing.

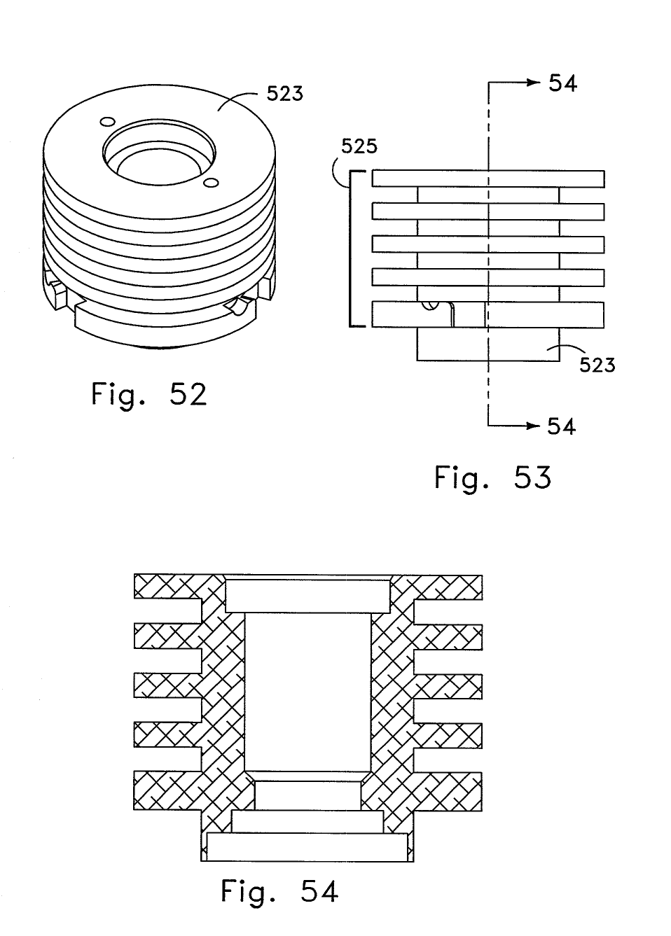

With reference to FIGS. 52-54, an optics holder 523 includes a plurality of radial fins 525 for increased heat dissipation.

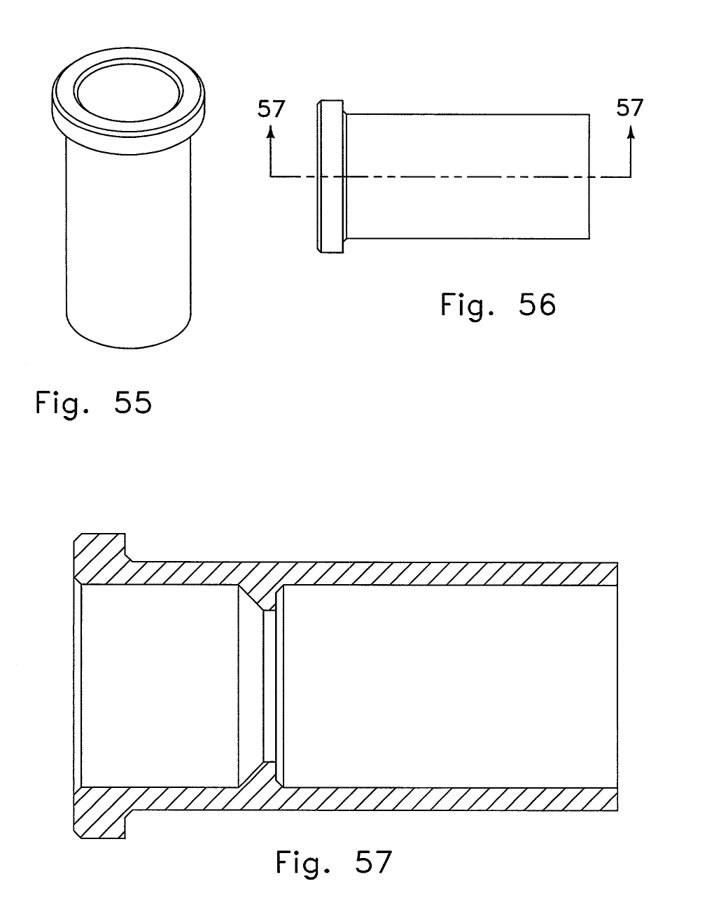

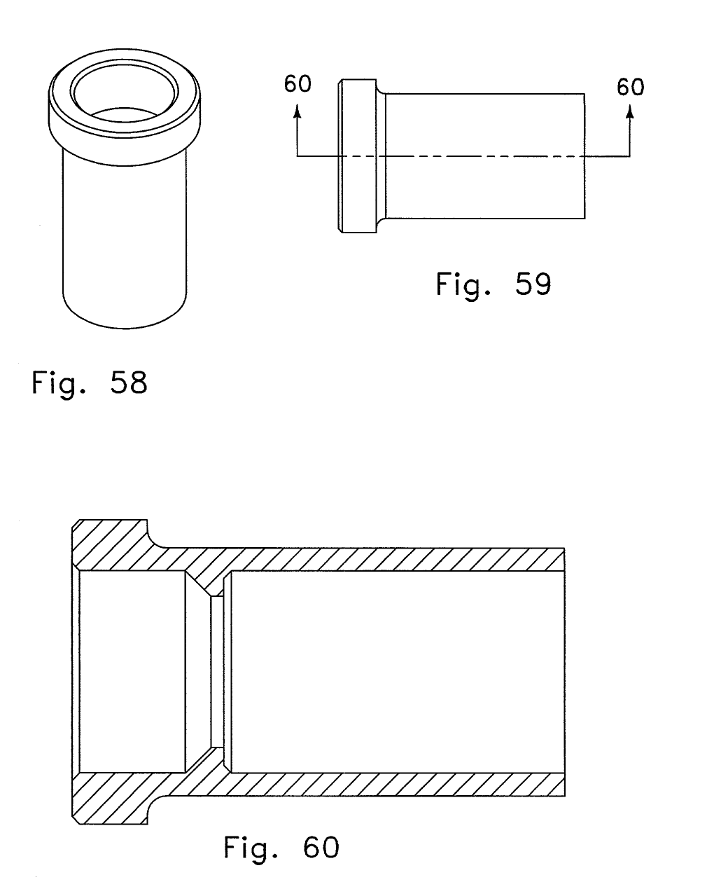

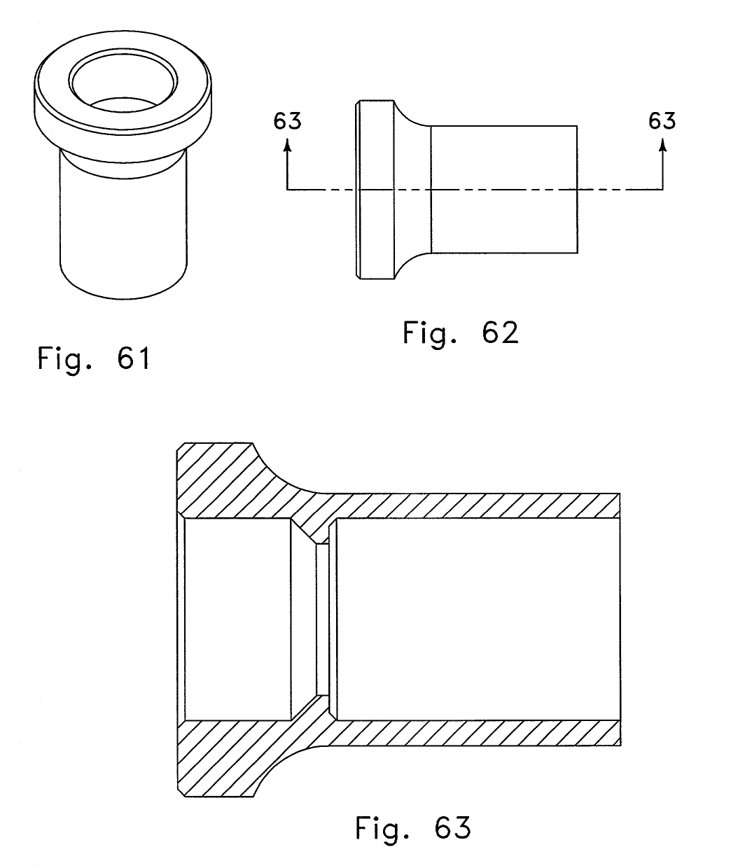

With reference to FIGS. 55-63, various aperture cups include a relatively small but thick front flange for improving heat conduction through the front of the aperture bulb.

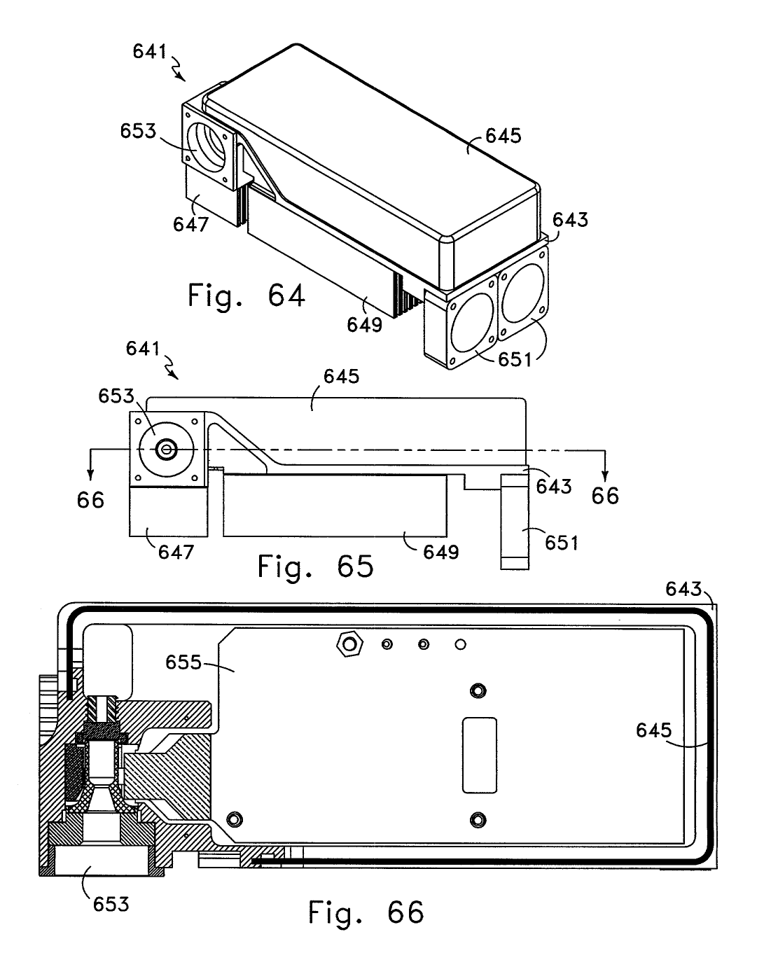

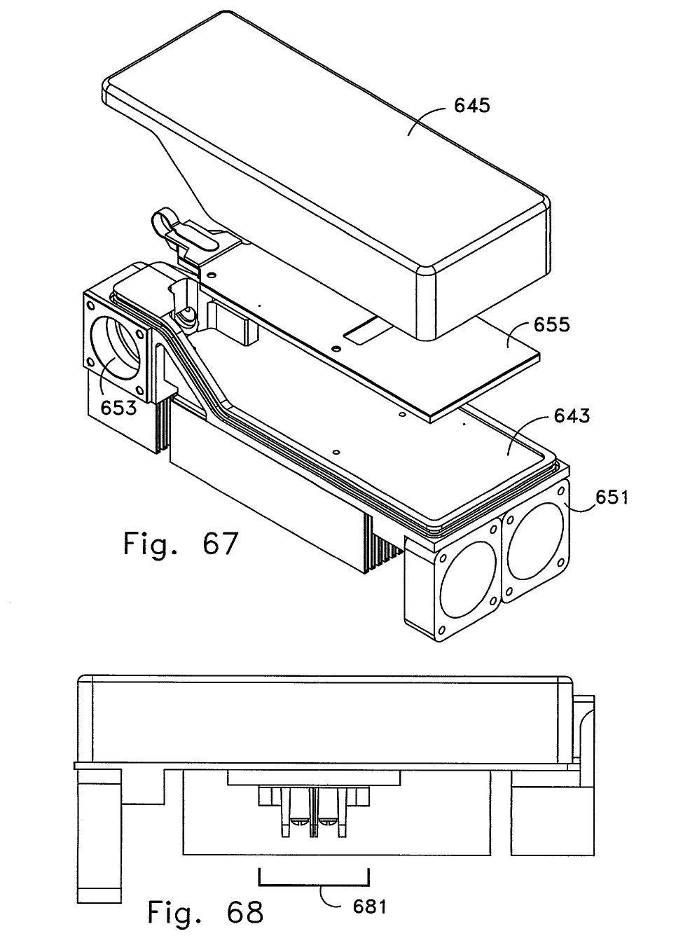

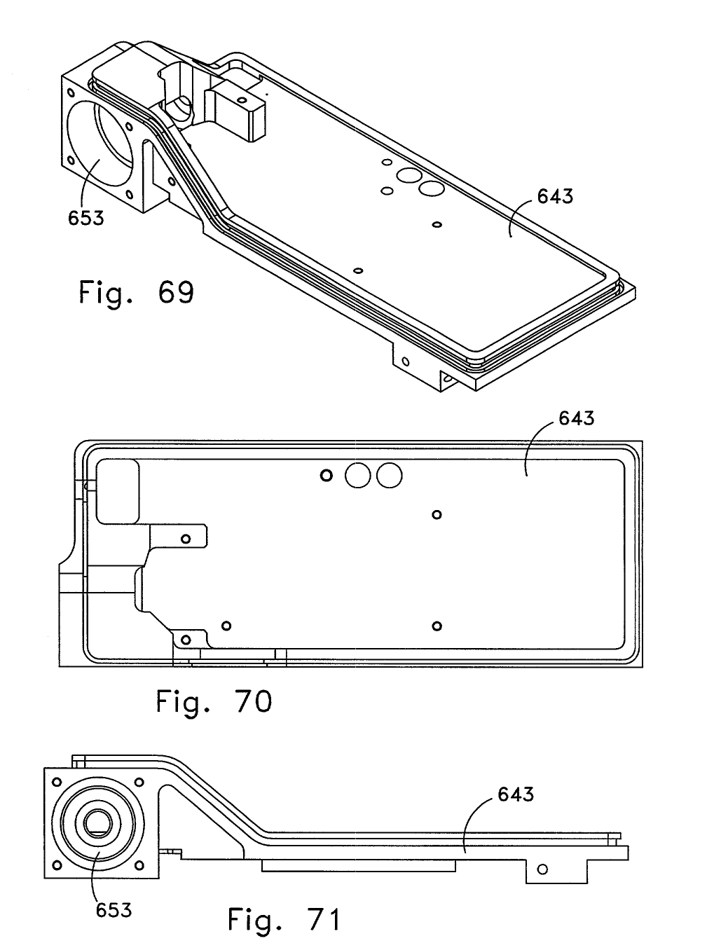

With reference to FIGS. 64-71, another example of a lamp system 641 includes a base 643 and a cover 645. A pair of folded fin heatsinks 647 and 649 are attached to the base in the main heat generating areas of the bulb and the RF board, respectively. A pair of fans 651 (blades not shown) are attached to the base 643 for blowing cooling air over the heatsinks 647, 649. A suitable bulb and optics assembly is positioned in a lighting emitting compartment 653 of the base 643. An RF board 655 (and optionally a control board) are disposed in the compartment defined by the base 643 and the cover 645. Power is provided to the lamp 641 by a pair of power terminals 681.

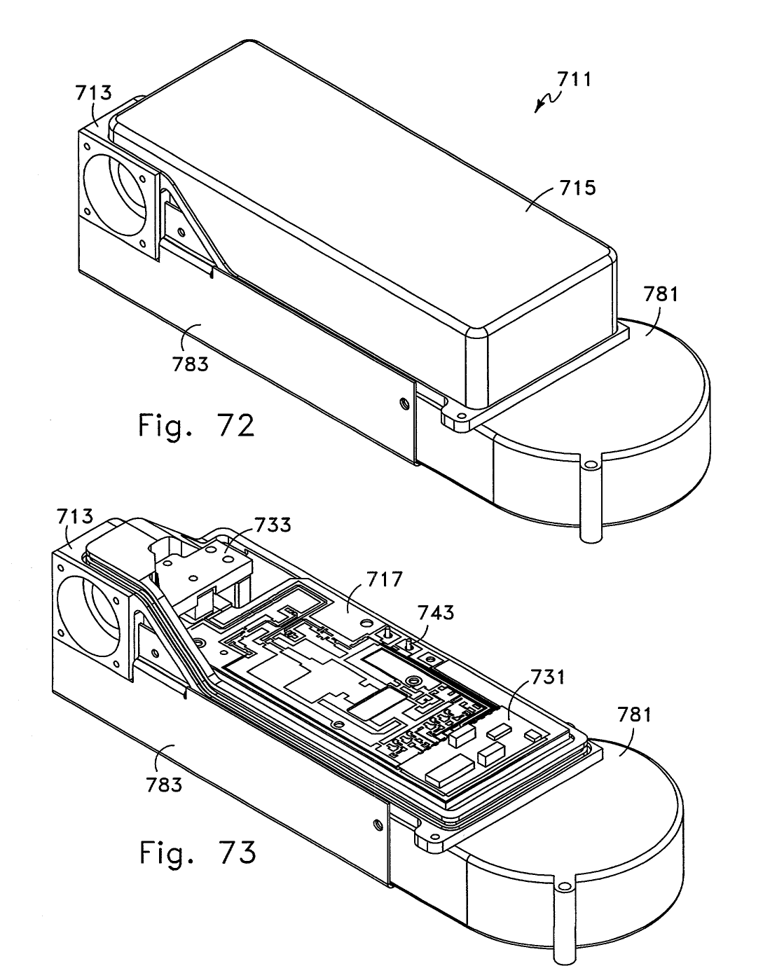

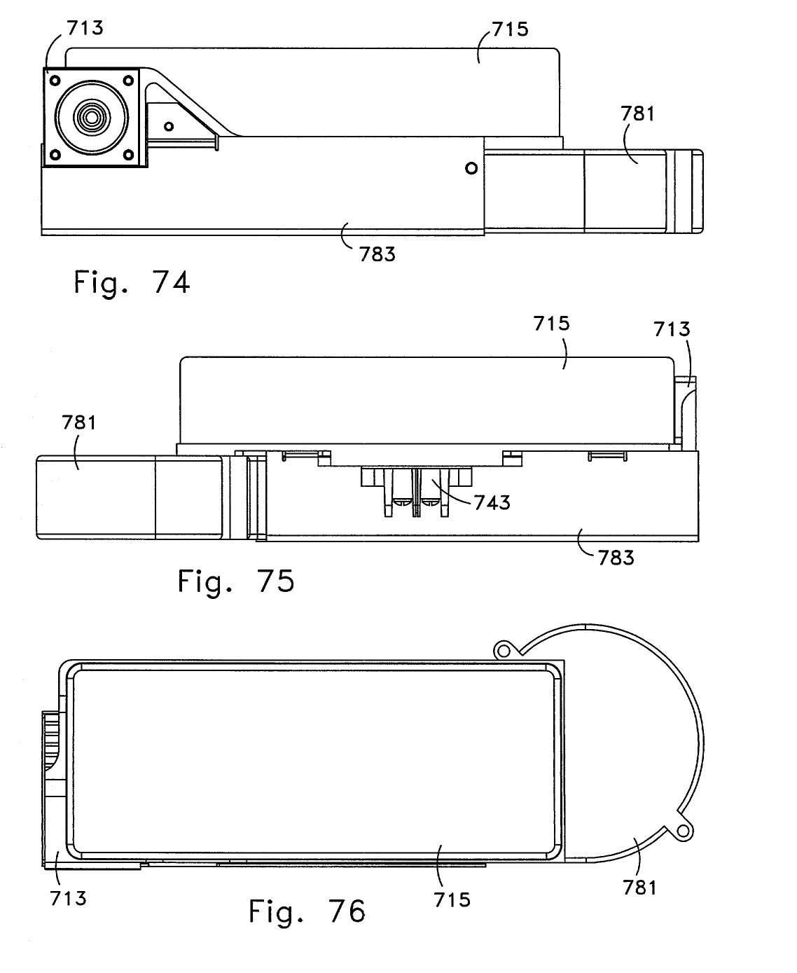

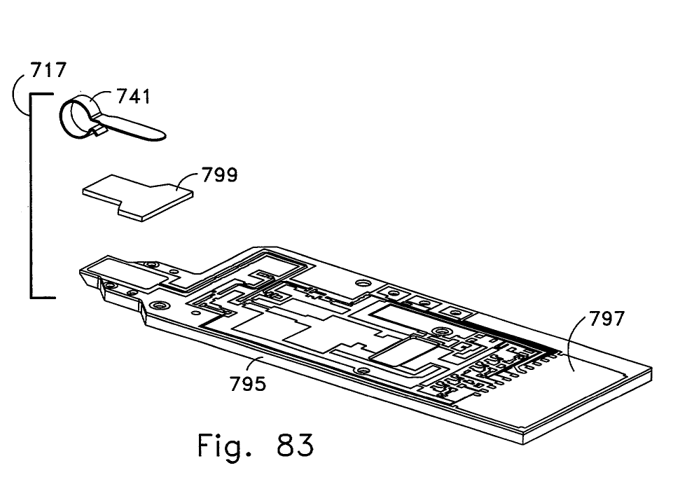

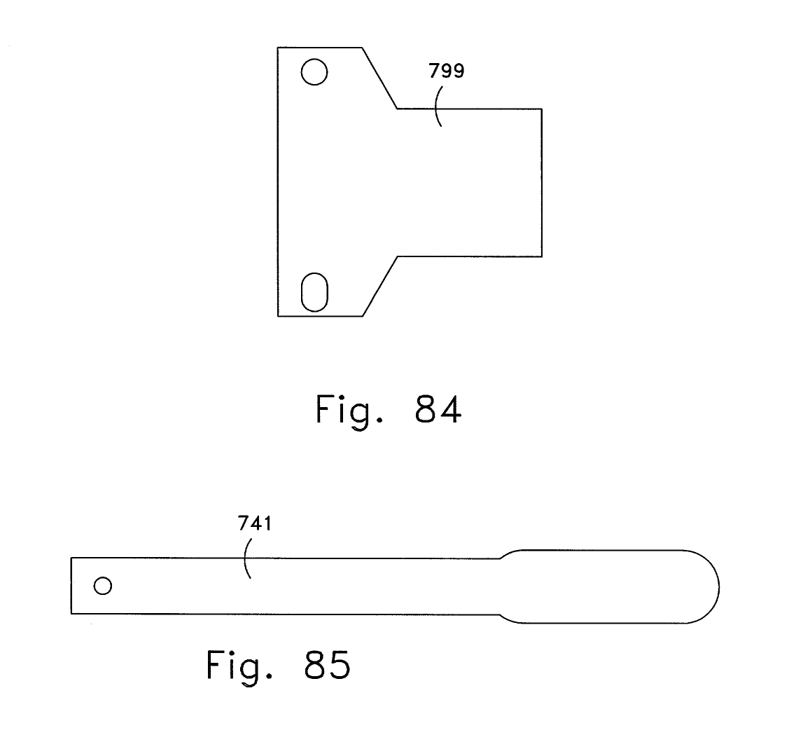

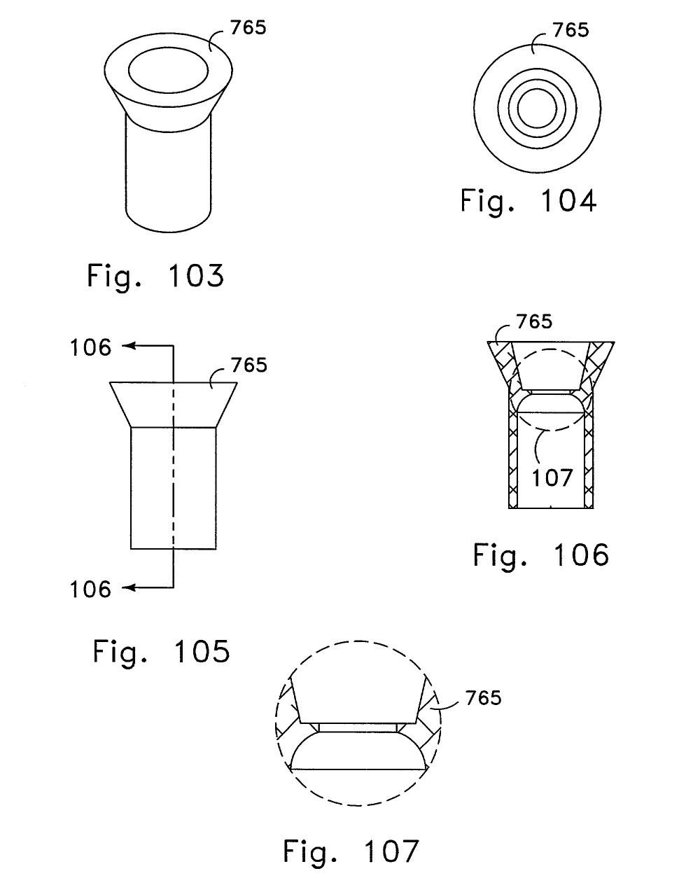

With reference to FIGS. 72-112, an integrated high brightness lamp 711 includes the following parts and assemblies: a housing assembly, thermal management parts and assemblies, an integrated RF board and lamp circuit assembly, an aperture bulb assembly, and an optional optics assembly. Each of these assemblies are hereinafter described in detail.

Housing Assembly

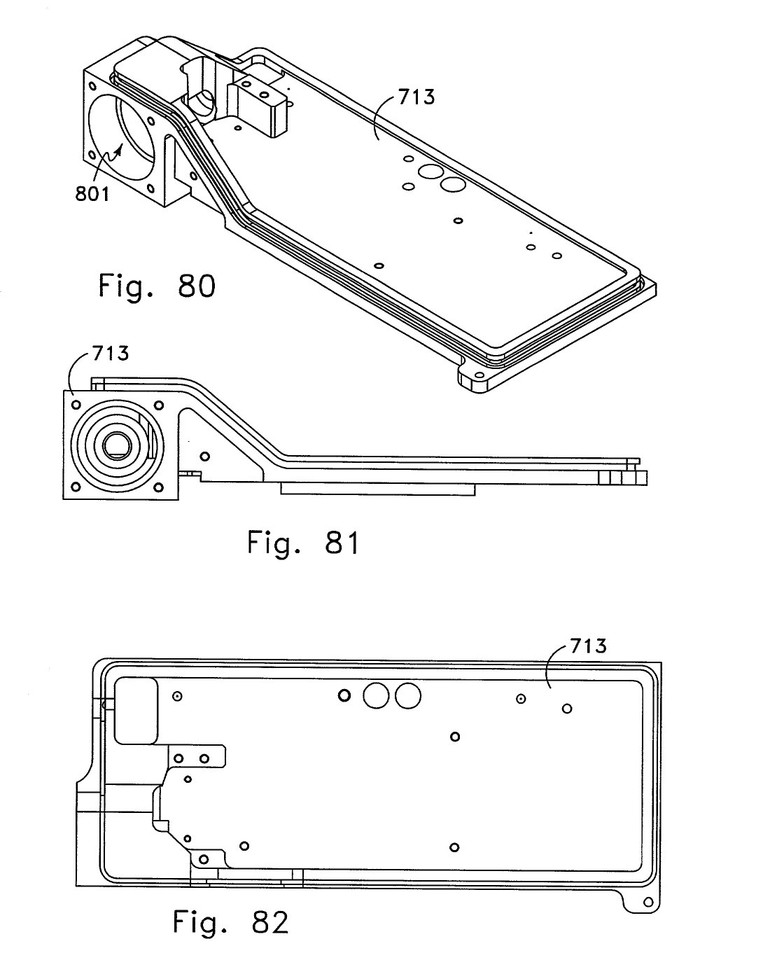

The housing assembly includes a base 713 and a lid 715. The base 713 defines an opening 801 (see FIG. 80) through which light is emitted. The opening 801 is adapted to receive the optics assembly and other lamp components.

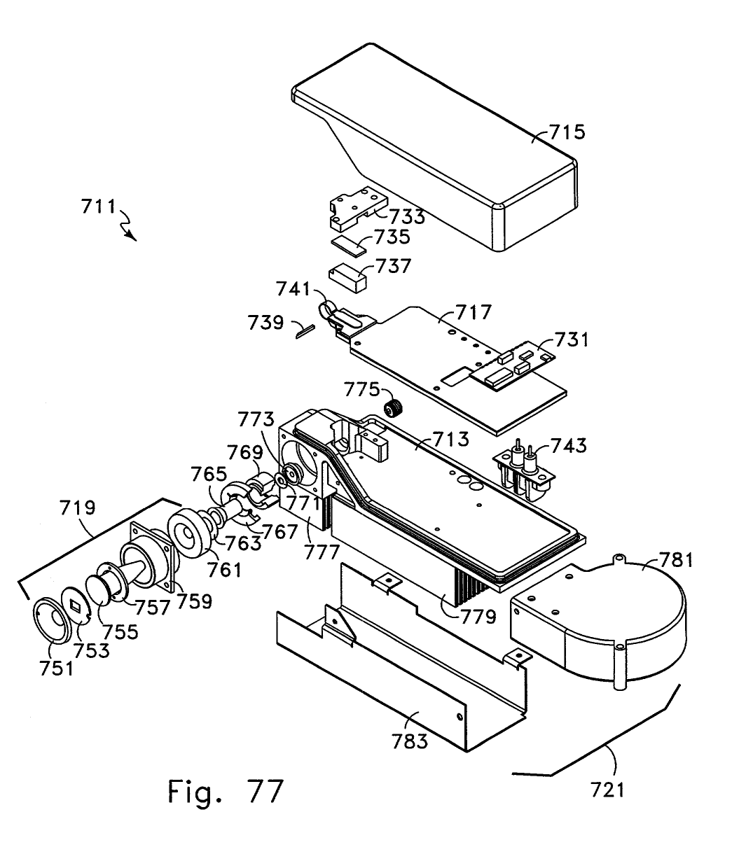

As described in detail above, the housing defines two or more internal compartments for mounting lamp components. In the illustrated example, one internal compartment is defined by the base 713 as opening 801 and another compartment is defined by the base 713 and the lid 715. For example, the opening/compartment 801 may contain a portion of an integrated RF board and lamp circuit 717. The compartment formed by the remainder of the base 713 and the lid 715 may contain the other portion of the integrated RF board 717, a control board 731, and power feedthrough pins and other interface circuitry. The power feedthrough pins are part of a DC terminal assembly 743 (see FIG. 77) which includes an RF filter for reducing RF emissions on the power input lines.

The lamp 711 is RF sealed to keep emissions below an acceptable level for interference. Components in the opening 801 define a choked down opening which is below cutoff for the operating frequency of the lamp 711. Small openings may be provided between the various compartments. An RF gasket may be positioned between the lid 715 and the base 713. Alternatively, conductive epoxy may be used to secure the lid 715 to the base 713 and provide an RF seal.

With reference to FIG. 79, a small ceramic block 739 (e.g. a sliver of boron nitride, see FIG. 77) is disposed in the throat of the coil 741 (in the gap between the leads). The ceramic block 739 reduces the tendency for arcing to occur in this area. The use of a low dielectric material such as BN for the block 739 minimizes any additional parasitic capacitances and similarly minimizes the concentration of electric fields due to the block 739. The block 739 provides a shield between heat and IR radiation from the bulb 791 and the capacitor stack (particularly the dielectric materials 797 and 799), thereby preventing overheating of the stack near the throat of the coil.

Thermal Management Parts and Assemblies

The thermal management assembly 721 includes a fan 781, a pair of folded fin heatsinks 777 and 779, and a shroud 783. Other thermal management parts include a ceramic coil heatsink 769, an aluminum aperture cup heatsink 767, a capacitor stack heatsink 737, and a threaded back plug assembly (sil pad 771, plug 773, and threaded plug 775).

With reference to FIGS. 77-79, a pair of folded fin heatsinks 777 and 779 are provided to dissipate the heat generated by the bulb and the heat generated by the RF transistor, respectively. The bottom side of the base 713 may define an elongated slot 803 (see FIG. 79) which acts as a thermal break between the lamp circuit and the RF circuit on the integrated RF board 717. A The base 713 and the heatsinks 777 and 779 define a plurality of corresponding mounting holes and may also include thermal epoxy between mating surfaces.

The heatsinks 777 and 779 have a plurality of heat dissipating fins. The lamp 711 includes a fan 781 (e.g. a blower) which directs cooling air over the fins. A shroud 783 may be disposed around the fins to contain the cooling air through the fins.

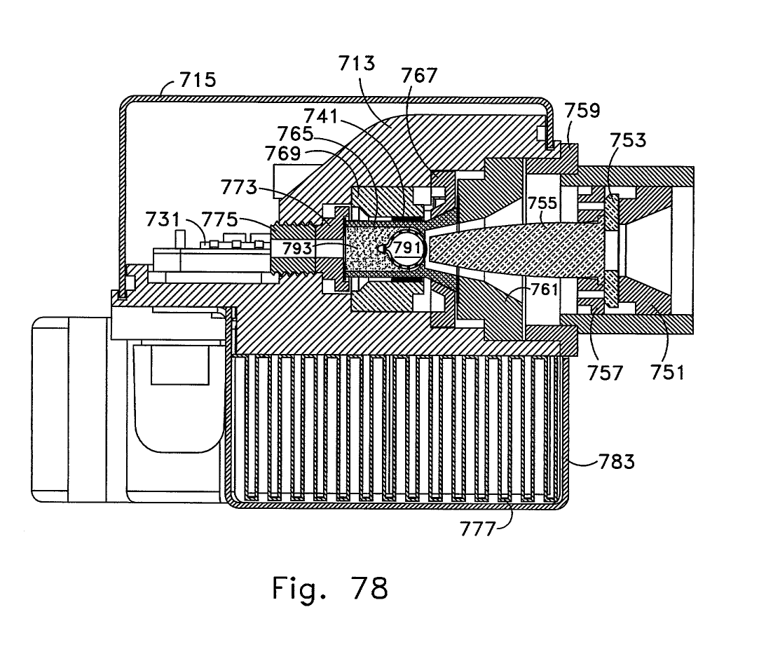

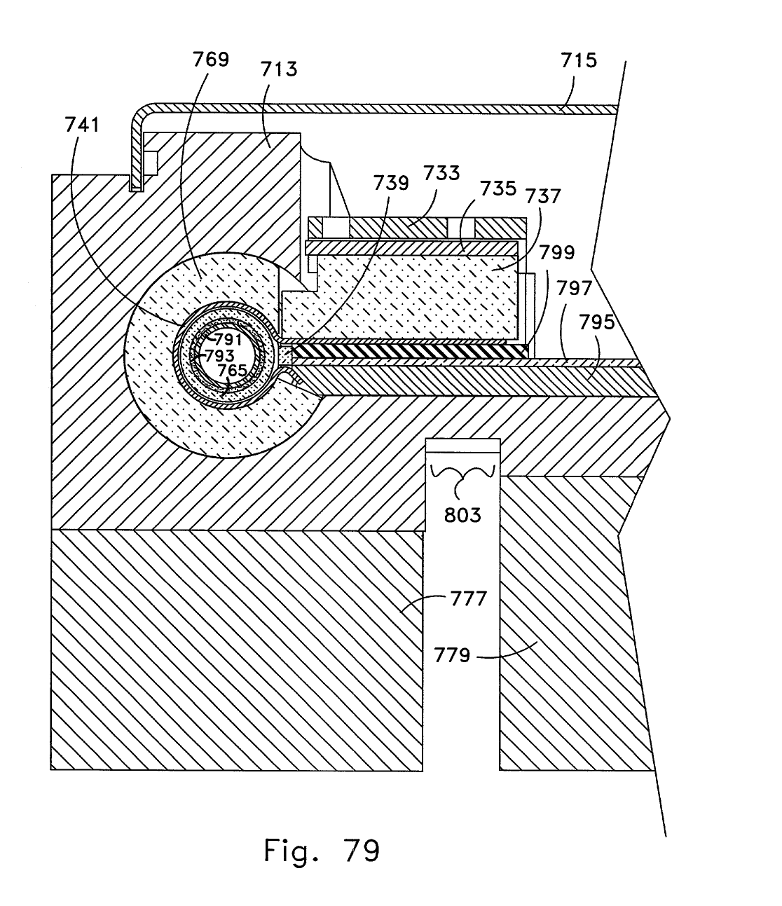

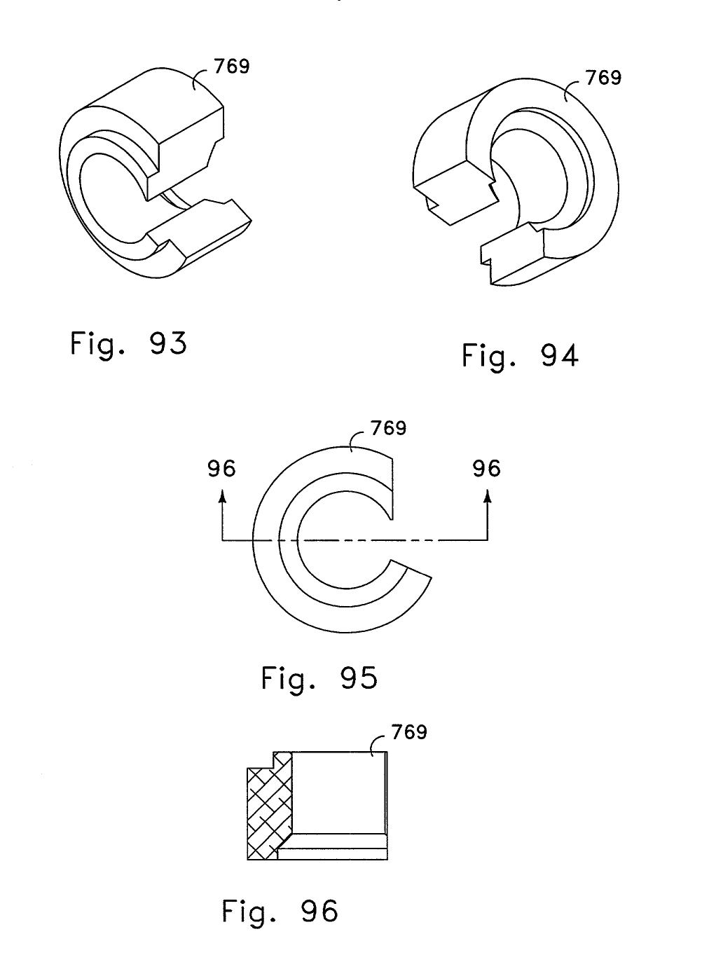

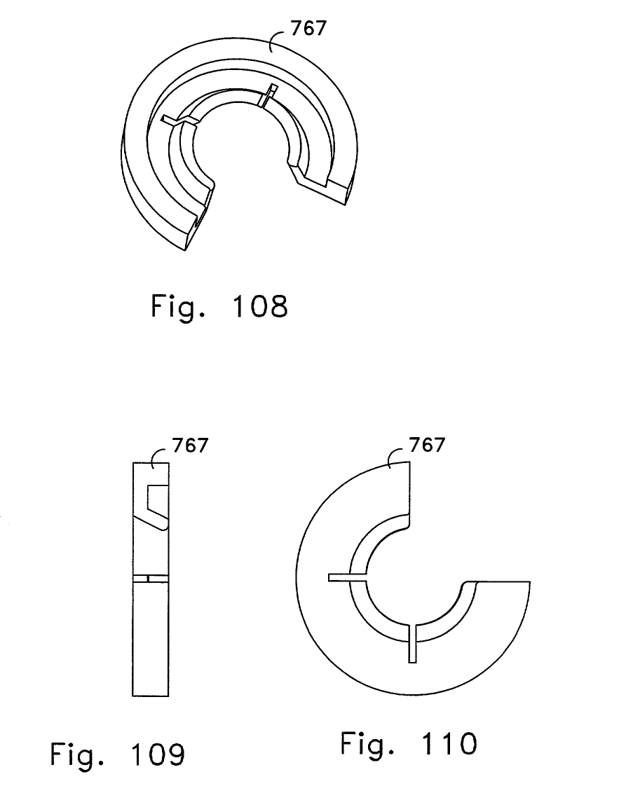

With reference to FIG. 78, the coil heatsink 769 is disposed around the coil 741 for transferring heat from the coil 741 to the base 713. The coil heatsink 769 is made from ceramic (e.g. boron nitride). Detailed drawings of the coil heatsink 769 are shown in FIGS. 93-96 The aperture cup heatsink 767 is positioned near the front of the aperture cup 765 for transferring heat from the sides of the cup 765 to the base 713. Details of the cup heatsink 767 are shown in FIGS. 108-110. The cup heatsink 767 may be made from aluminum. A sil pad 763 (see FIG. 77) may be positioned between the front of the cup 765 and the optics assembly 719 (e.g. retaining ring 761). The sil pad 763 is made from high temperature rated, resilient, and thermally conductive material.

The cup 765 may also be cooled from the back. A plug 773 is positioned against the back of the cup 765. A sil pad 771 may be disposed between the cup 765 and the plug 773. A threaded plug 775 is positioned against the plug 773 such that by turning the threaded plug 775, the plug 773 is biased against the back of the cup 765. The cup 765 is effectively sandwiched between the optics assembly 719 and the plug 773.

With reference to FIG. 79, the integrated RF board and lamp circuit 717 includes a resonant lamp circuit utilizing a capacitor stack. As described more fully in the above mentioned '161 publication, the capacitor stack benefits from thermal management. The capacitor stack includes a heat spreader plate 795, a printed circuit board 797, a piece of dielectric material 799, and a lead of the coil 741.

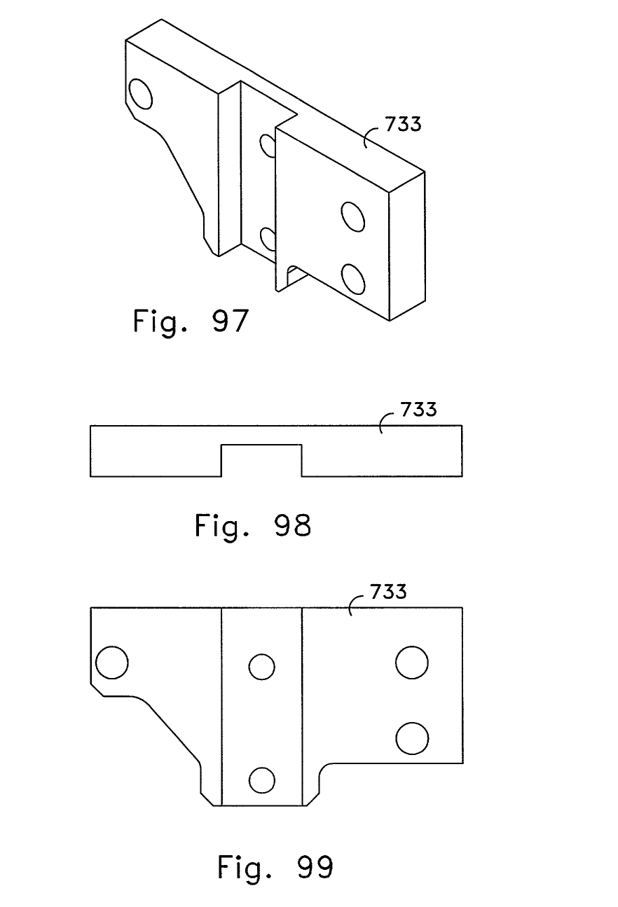

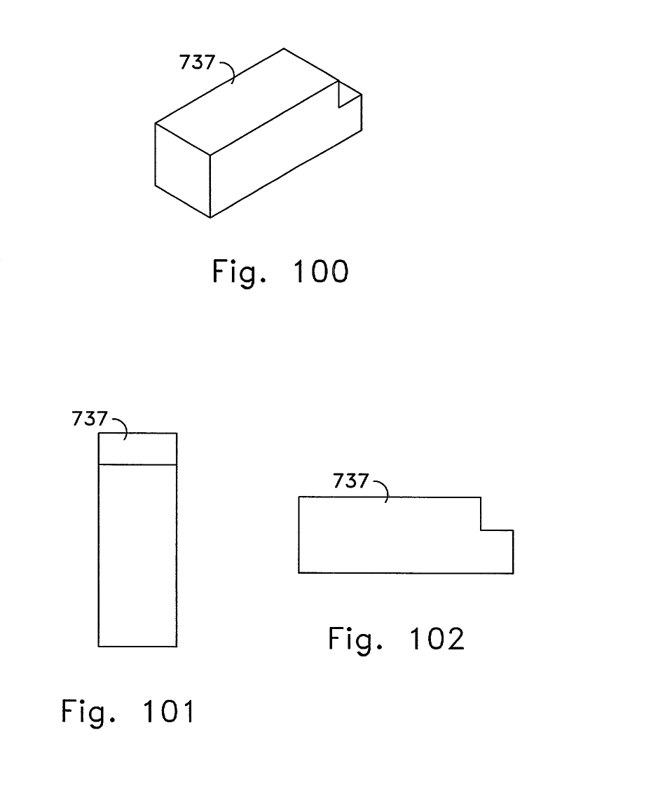

A tuning structure includes a tuning bridge 733 connected to the base 713, a pressure plate 735, and a tuning block 737. Details of the tuning bridge 737 are shown in FIGS. 97-99. Details of the tuning block 737 are shown in FIGS. 100-102. A pair of screws are threaded through the bridge 733 to apply pressure to the plate 735 and the block 737. The resonant frequency of the lamp head may be adjusted by modifying the tuning block 737. The tuning structure adds a parasitic capacitance to the lamp circuit. Making the block 737 more narrow (e.g. by milling the sides) tends to decrease the capacitance and increase the resonant frequency of the lamp head. Making the block 737 shorter (e.g. by milling the top or bottom) tends to increase the capacitance and decrease the resonant frequency of the lamp. Preferably the tuning block is made from thermally conductive ceramic (e.g. boron nitride) so that the tuning block 737 performs the additional role of transferring heat from the capacitor stack to the base (via the tuning bridge).

Integrated RF Board and Lamp Circuit Assembly

The integrated RF board and lamp circuit assembly 717 includes a printed circuit board 797 populated with component parts for a power oscillator, a heat spreader plate 795, an RF control board 731 populated with component parts for a micro-controller programmed to control various aspects of the RF board, an integrated capacitor and coil assembly including an excitation coil 741 and a capacitor stack (including dielectric 799). The excitation coil 741 is disposed in the opening 801. The excitation coil 741 has a general wedding ring shape.

The integrated RF board 717 and the control board 731 may be configured as described in the above mentioned '161 publication. In the present example, the control board 731 is provided with wire leads which are bent around the edges of the board so that they align with corresponding pads on the RF board 717. The leads of the control board 731 are then soldered to the pads of the RF board 717 in a manner similar to the mounting of surface mount components. An alternative preferred configuration for the control board 731 is to provide the control board with connection pads on the underside of the board 731 which physically align with corresponding pads on the RF board 717 and mounting the control board 731 on the RF board 717 in essentially the same manner as other surface mounted components on the RF board 717. The use of surface mount pads on the control board 731 reduces the amount of wiring that is susceptible to electromagnetic interference and simplifies manufacturing.

In general, RF energy generated by the RF board 717 is transferred to the coil 741 which couples the energy to a fill in the bulb 791. The excited fill emits light which exits the aperture cup 765 through the aperture defined in the front of the cup 765. A portion of the light from the aperture bulb is collected by the CPC 755 and directed out through the opening 801. The light from the lamp 711 may be further acted on by external optics as may be necessary or desirable for a particular application. Other details regarding the construction and operation of suitable lamp components my be had with reference to the '237 patent and the '161 publication.

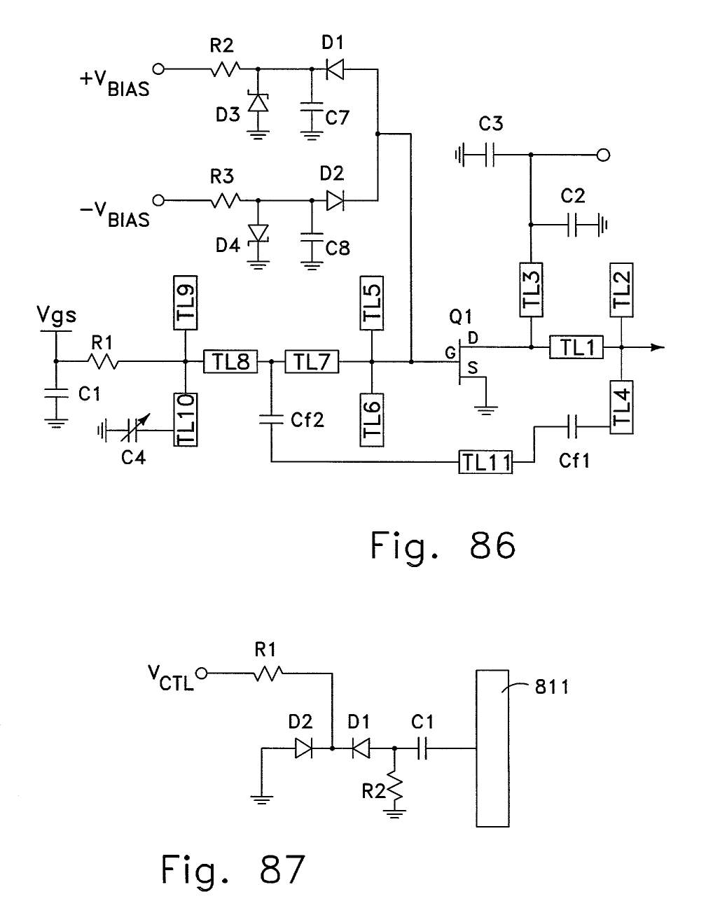

In the present integrated high brightness lamp, RF power in excess of 200 RF wafts is provided relatively efficiently by a power oscillator utilizing Class F amplifier principles. Such Class F principles are discussed in detail in PCT Publication No. WO 02/23711. FIG. 86 is a schematic diagram of the power oscillator including a gate clamping circuit which protects the transistor Q1 from an over-voltage condition on its gate. The variable capacitor C4 represent a tuning circuit which can adjust the frequency of the oscillator over a range. A preferred tuning circuit is shown in FIG. 87. A pair of varactor diodes are connected in a complementary arrangement to provide a variable capacitance on a tuning stub 811 of the oscillator circuit. Specifically, an anode of a varactor diode D1 is connected to an anode of a varactor diode D2. The cathode of the diode D2 is connected to ground. A control voltage Vctl is connected to one end of a resistor R1 and the other end of R1 is connected to the junction of the diode D1 and D2. The cathode end of the diode D1 is connected to a junction of a capacitor C1 and a resistor R2. The other end of the resistor R2 is connected to ground. The other end of the capacitor C2 is connected to the tuning stub 811. A plurality of such complementary varactor diode tuning networks my be attached to the tuning stub 811.

In operation, the frequency of the oscillator may be adjusted by changing the reverse bias voltage (e.g. Vctl). For example, in the example given below, the oscillator is tuned over a range of 9 MHz by varying the control voltage between 2 and 22 volts. The frequency adjustment is relatively linear with voltage. The coupling capacitors have a value selected to limit the amount of current through the varactor diodes. For example a 1.2 pF capacitor limits the RF current through the varactors to less than their 50 mA rating at an effective RF voltage of 8V on the coupling capacitor. Advantageously, the tolerance requirements for the coupling capacitors are not as strong as comparable tuning circuits employing PIN diodes. Moreover, the varactor diode tuning circuit avoids power losses associated with comparable tuning circuits employing PIN diodes.

Alternative tuning arrangements are described in the '237 patent and the '161 publication. A novel alternative tuning circuit uses a digital tuning circuit. For the digital tuning circuit, a network of capacitors are attached to the tuning stub by respective switches and the amount of capacitance on the tuning stub is controlled by selectively activating the switches. For example, four capacitors have binary weights of 1, 2, 4, and 8 corresponding to progressively increasing effect on the operating frequency. For example, the four capacitors may have increasing capacitance values of 0.70 pF, 1.12 pF, 1.65 pF, and 2.30. The capacitors may be connected to the tuning circuit by respective PIN diodes where when the PIN diode is ON the corresponding capacitor is attached to the tuning circuit and when the PIN diode is OFF the capacitor is removed from the circuit. Because the PIN diodes are utilized in a hard ON/hard OFF configuration, the digital tuning circuit has less power loss than comparable analog PIN diode tuning circuits.

Another novel tuning circuit utilizes a combination digital and analog tuning circuit. A completely digital tuning circuit provides a discrete set of frequencies available from the oscillator. This may result in a less than optimal match with the lamp head. A combination of digital tuning (as described in the preceding paragraph) together with a single analog tuning circuit (e.g. a PIN diode in series with a small capacitance—about 1 pF; or a varactor tuning circuit) represents a compromise between the low power loss of the digital circuit and the advantage of continuous tuning of the analog circuit.

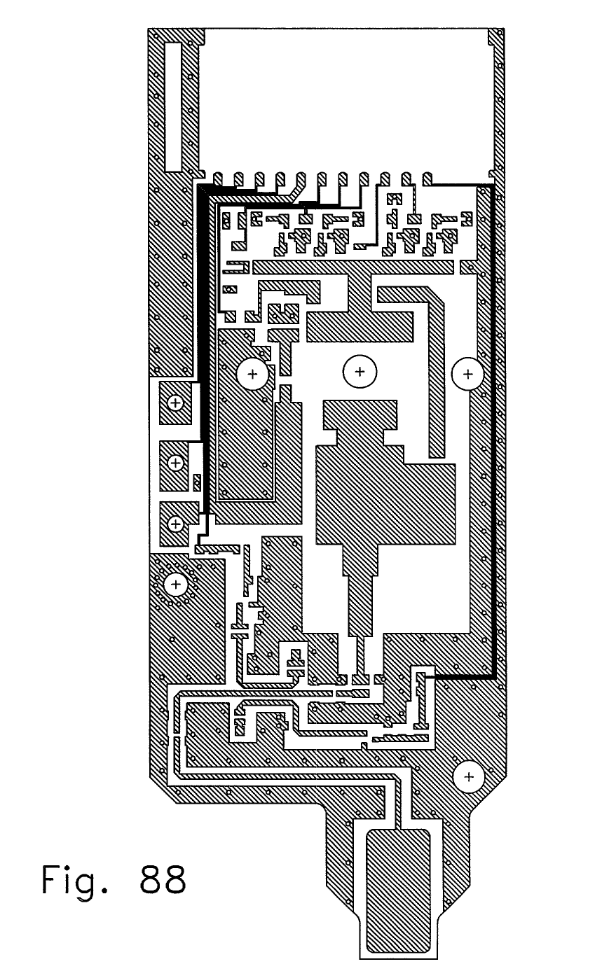

With reference to FIG. 88, an example printed circuit board layout is shown for the power oscillator. With reference to FIG. 89, example component parts include:

| Designation | Description |
|---|---|
| C1 | 4.7 uF capacitor |
| C2 | 4700 pF capacitor |
| C3 | 470 pF capacitor |
| C4, C5 | 560 pF capacitor |
| C6-C9 | 1.0 pF capacitor (+/− .1 pF) |
| C10 | 1.6 pF capacitor (+/− .1 pF) |
| C11 | 10 uF capacitor |
| C12 | 1000 pF capacitor |
| C13 | 20 pf capacitor |
| C14 | 0.9 pF capacitor (+/− .1 pF) |
| C15 | 130 pF capacitor |
| C16, C17 | 39 pF capacitor |
| C18, C19 | 0.1 uF capacitor |
| C20, C21 | 1.0 uF capacitor |
| C22, C23 | 20 pF capacitor |
| C24 | 2.1 pF capacitor (+/− .1 pF) |
| D1, D2, D3 | PIN diode (High power - M/A COM MA4P7002F-1072) |
| D4, D5 | Diode |
| D6 | Zener diode, 6.2 V 1.5 W |
| D7 | Zener diode, 15 V, 1.5 W |
| D8-D15 | Varactor diode (M/A COM MA4ST401-287) |
| L2 | Hand wound inductor (18 AWG) |
| L3, L7, L8 | 2.5 nH inductor, 1.6 A |
| L4, L9 | 5.6 nH inductor, 1.6 A |
| L5, L6 | 39 nH inductor |
| Q1 | LDMOS RF power transistor (Ultra RF U10180) |
| R1, R2 | 3.32 K ohm resistor |
| R3 | 4.7 K ohm resistor |
| R4 | .003 ohm resistor (1 W, 1%) |
| R5 | 100 K ohm resistor (1%) |
| R6, R7 | 68 ohm resistor (2%) |
| R8, R9 | 50 ohm resistor |
| R10, R11 | 2200 ohm resistor |
| R13-R20 | 10 K ohm resistor |

The RF source may be reduced in size by utilizing hybrid design principles. With a hybrid design, a combination of distributed and lumped components (e.g. micro-strip and discrete devices) are selected to reduce the circuit size while providing the same circuit function. For example, a relatively long micro-strip transmission line can be replaced with a relatively short micro-strip transmission line and a discrete component (e.g. a capacitor or an inductor).

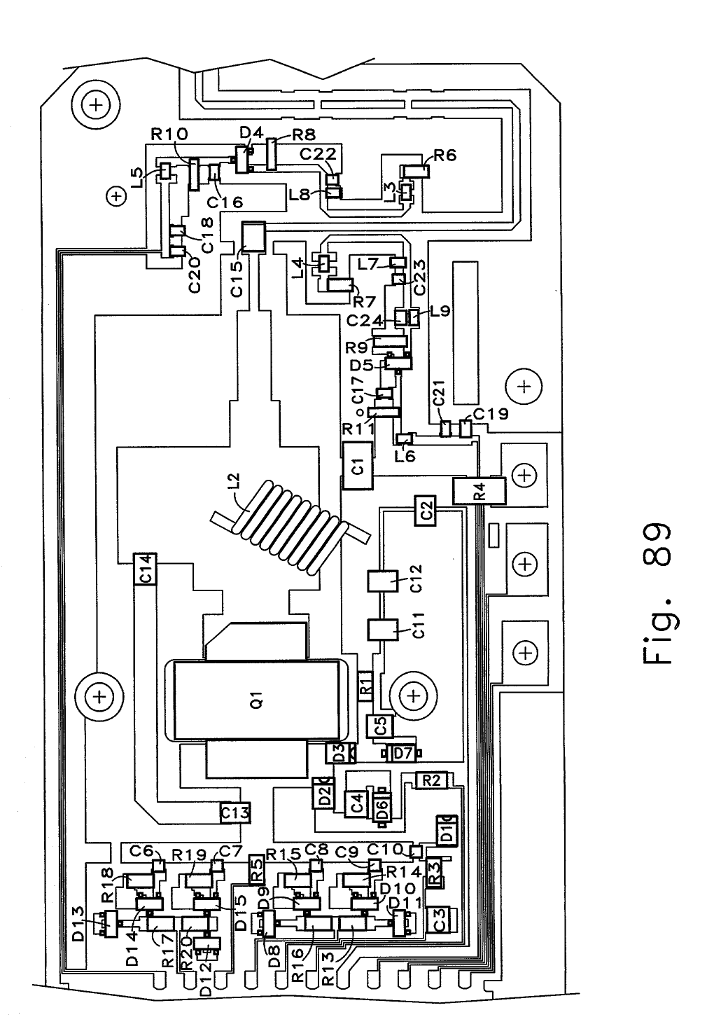

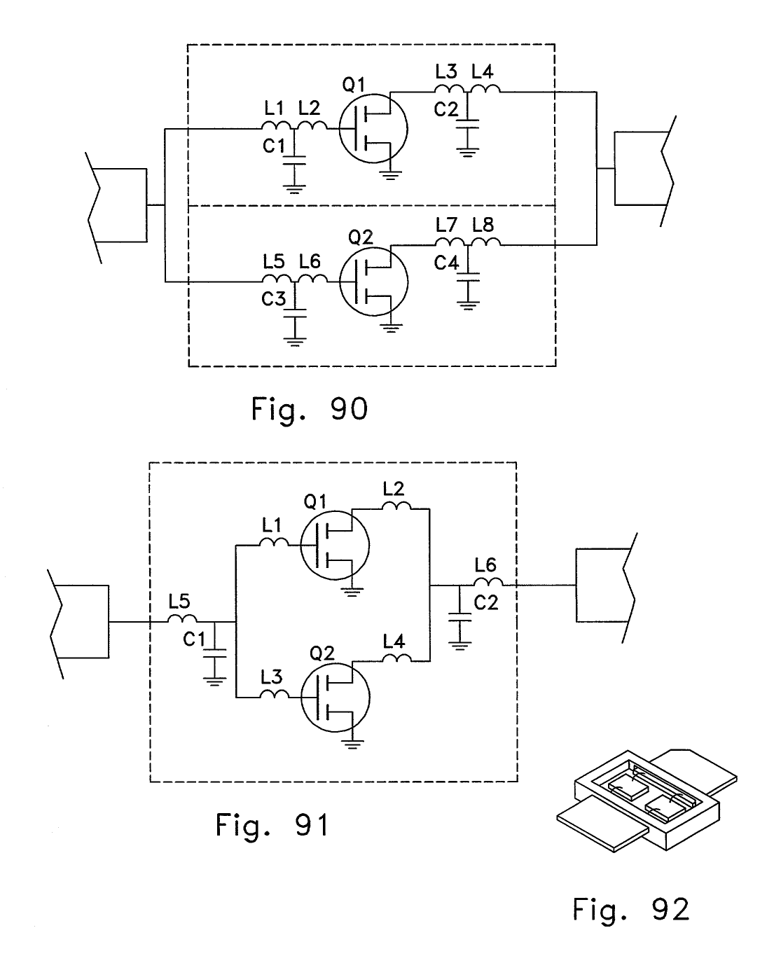

The transistor Q1 is a high power multi-die transistor having the general structure shown in FIG. 91. An example of this transistor is made especially for Fusion Lighting by Ultra RF under the designation U10180. Prior multi-die or multiple parallel transistor configurations cannot effectively be used as a power oscillator at frequencies above about 500 MHz due to a self oscillation problem relating to the small inductance and capacitance in the leads themselves (although no problem exists with respect to the use of such devices as power amplifiers). With reference to FIG. 90, L1 and C1 represent the inductance and capacitance present in the lead itself and L2 represents the inductance of the wire bond. Q1 and Q2 represent the transistor die. In a multi-package arrangement or a multi-die package with multiple leads, corresponding inductances and capacitances are associated with each wire bond (L3, L6, and L7) and each lead (L4/C2, L5/C3, and L8/C4). Small differences in the transistor characteristics and/or small differences in the electrical characteristics of the different leads and wire bonds are believed to cause a self oscillation at frequencies above about 500 MHz, preventing efficient operation of a power oscillator above the self oscillation frequency. In accordance with a present aspect of the invention, the input and output of each die in a multi-die package are connected to a respective single leadframe (see FIGS. 91-92). With the present invention, a power oscillator can be configured with a multi-die transistor package at frequencies above 500 MHz. The present example oscillates at above 700 MHz.

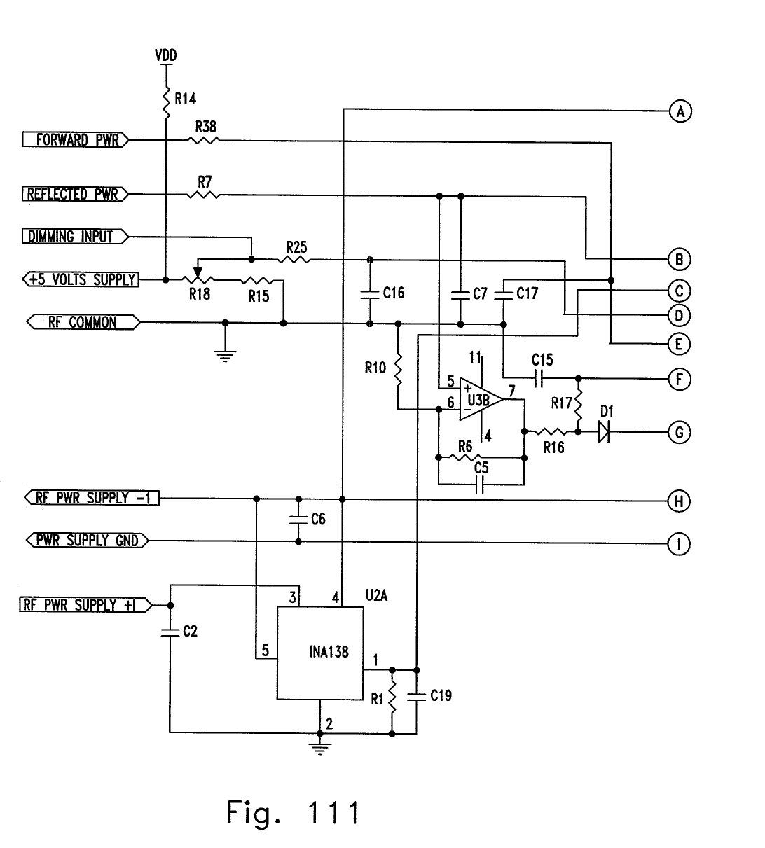

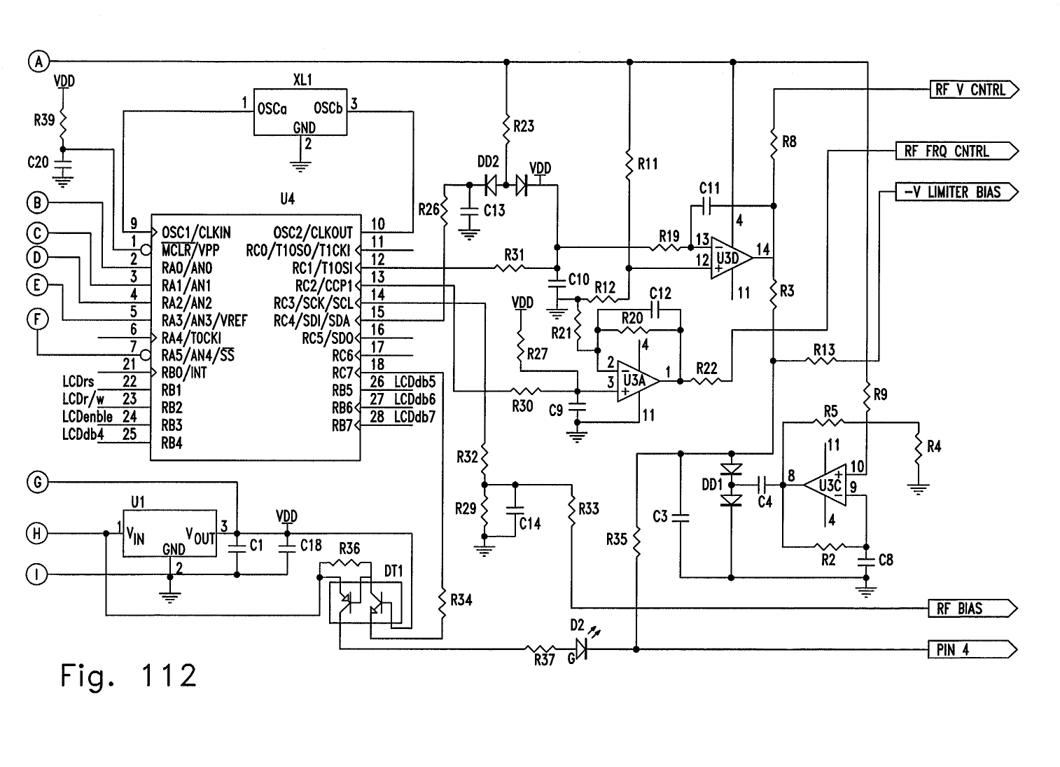

As mentioned above, the power oscillator is tunable over a range of frequencies. The RF control board provides such tuning as well as controlling other functions of the power oscillator. An example schematic of a preferred RF control circuit is shown in FIGS. 111-112 with lettered connection points A-I indicating connections across the drawing sheets. The control circuit receives inputs such as forward power, reflected power, and a dimming input, together with various system voltages and ground references. The control circuit provides various control signals to the RF board, such as the frequency control voltage and various bias voltages. The control circuit utilizes a micro-controller such as model no. PIC16F873 available from Microchip.

A preferred tuning algorithm for the RF control circuit involves three tuning stages which may be referred to as coarse tuning, medium tuning, and fine tuning. Coarse tuning is used initially during startup. During coarse tuning, the algorithm adjusts the oscillator frequency based on a detected amount of current drawn by the oscillator. The present inventors have determined that drawn current is a more reliable indicator than reflected power during the initial starting of the lamp. For example, if the detected amount of current drawn from the transistor is below a first threshold, the frequency is adjusted until the current increases above the first threshold; and if the amount of current drawn from the transistor is above a second threshold, the frequency is adjusted until the current decreases below the second threshold. Faster starts have been achieved using coarse tuning based on drawn current. After a pre-determined event (e.g. a period of time or a condition of the detected drawn current), the algorithm switches to medium tuning. During medium tuning, the frequency of the oscillator is adjusted based on a detected amount of reflected power in a manner similar to that described in the '161 publication. After another pre-determined event (e.g. a period of time or a condition of the detected reflected power), the algorithm switches to fine tuning using an amplified signal and a higher resolution micro-controller.

Another method for adjusting the RF control circuit involves increasing the forward power. Prior methods have focused on reducing reflected power to ensure a good match between the RF source and the lamp head and also to reduce destructive feedback. In accordance with the present aspect of the invention, at some time after the reflected power has been minimized, the control circuit adjusts the frequency of the RF source to maximize forward power, while maintaining reflected power under an acceptable range. For example, when the reflected power is determined to be low enough to be non-detrimental to the oscillator, the algorithm adjusts the frequency of the oscillator and determines the effect on the forward power. The algorithm continues to adjust the frequency as long as the forward power is increasing and the reflected power remains below a pre-determined threshold. An advantage of increased forward power is greater light output from the lamp.

Aperture Bulb Assembly

The aperture bulb assembly includes a ceramic aperture cup 765 defining a light emitting aperture, a bulb 791 filled with light emitting material disposed inside the aperture cup 765 and positioned against the aperture, and reflective ceramic material 793 surrounding the bulb 91 except in the area of the aperture (see FIGS. 78-79). The bulb 791 is roughly centered with respect to the coil 741 (see FIGS. 78-79). Details of the aperture cup 765 are shown in FIGS. 103-107.

A preferred material for the cup 765 is zirconia toughened alumina (ZTA). Alumina does not react with quartz at the operating temperature of the lamp. ZTA is rated for a thermal shock of about 300° C.

As shown in FIG. 106, the cup 765 is cylindrical in the region 821 which holds the bulb and then flares out in a neck portion 823 from the aperture to the front face 825 of the cup 765 (see FIG. 105). According to a present aspect of the invention, a thermal path is provided through the neck portion 823 of the bulb (see FIG. 78).

With reference to FIG. 107, a portion of the cup 765 which defines the aperture is relatively thin. The thickness of the plate which defines the aperture represents a compromise between thermal conductance from the aperture region and a reduction of transmitted light due to the depth of the aperture and the reflectance of the cup material (e.g. alumina or ZTA).

Optics Assembly

With reference to FIGS. 77-78, the optics assembly 719 includes an optics holder 759, a compound parabolic concentrator (CPC) 755, a remote aperture 753, and several retaining rings 751, 757, and 761. Light emitted from the bulb 791 is collected and collimated by the CPC 755. The remote aperture 753 defines the output window. Light not emitted by the remote aperture 753 is reflected back into the bulb 791 for recycling.

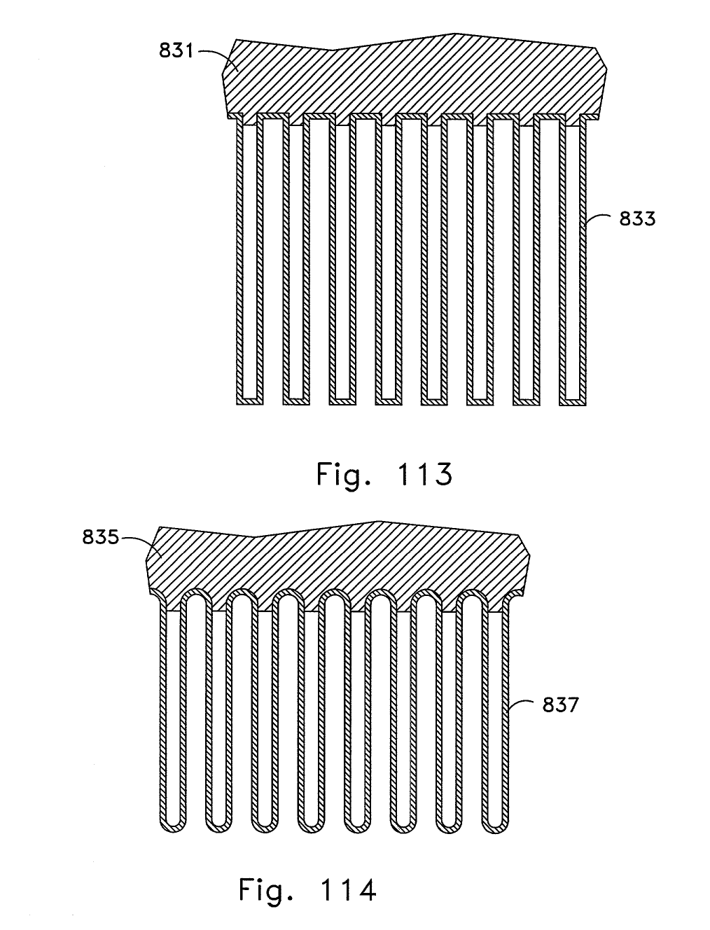

With reference to FIG. 113, an integrated lamp includes a base 831 with a scalloped heat sink surface adapted to mate with a folded fin heatsink 833. Advantageously, heat transfer is improved without increasing the mass of the lamp. The design of aluminum packages for heat sinking power electronics assemblies involves a trade-off between cost, ease of assembly, and weight. In several examples given above, the lamp base has a flat surface with aluminum finned heat sinks attached thereto. Another approach is to integrate the heat sink fins directly onto the lamp base (e.g. by casting). The integrated structure has the advantage of reducing the mass as compared to separate structures. In FIG. 113, the base 831 is contoured on its outer surface to mate with the folded aluminum heat sink (or a set of such heat sinks). The package weight is reduced and if the base is used to mount electronic component the processing time is reduced because the reduced mass of the base requires less time to raise the temperature of the base to soldering temperatures.

The use of contoured and mating surfaces allows the design of a wide range of effectively closed air circulation systems without the addition of further plenum structures. FIG. 114 is another example of a lamp base 835 with a contoured outer surface which mates with a folded fin heatsink 837.

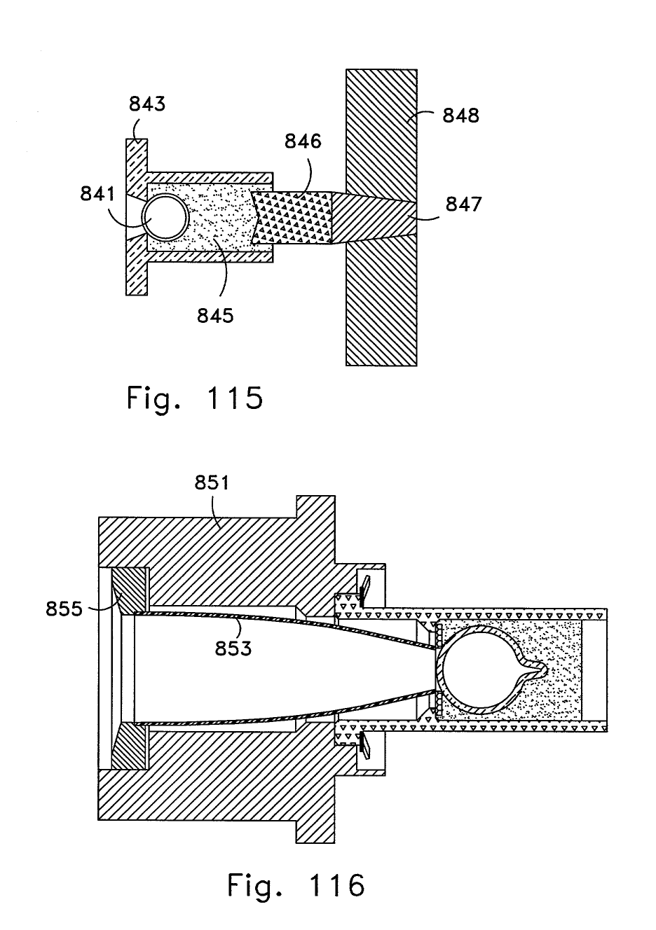

With reference to FIG. 115, a thermally management structure for the bulb is shown which can be adapted to a variety of lamp systems, including any of the lamp systems described herein. An electrodeless bulb 841 is contained inside a ceramic cup 842 and encased in reflective ceramic material 845. A high thermal conductivity rod 846 is in contact with the material 845 at the back of the cup 843 (opposite of the light emitting aperture). Heat is transferred from the ceramic rod 846 to a metal rod 847 where it is dissipated by a metal heat radiator 848. The temperature of the bulb surface may be increased or decreased by adjusting the distance between the back of the bulb and the rod 846.

With reference to FIG. 116, an optics assembly includes an optics tube 851 with a hollow CPC 853 disposed therein. A threaded retainer ring 855 is configured with a shoulder adapted to mate with an outside diameter of the CPC 853. The CPC 853 is captured between the holder 855 and the aperture bulb. The holder 855 helps position the CPC 853 over the aperture.

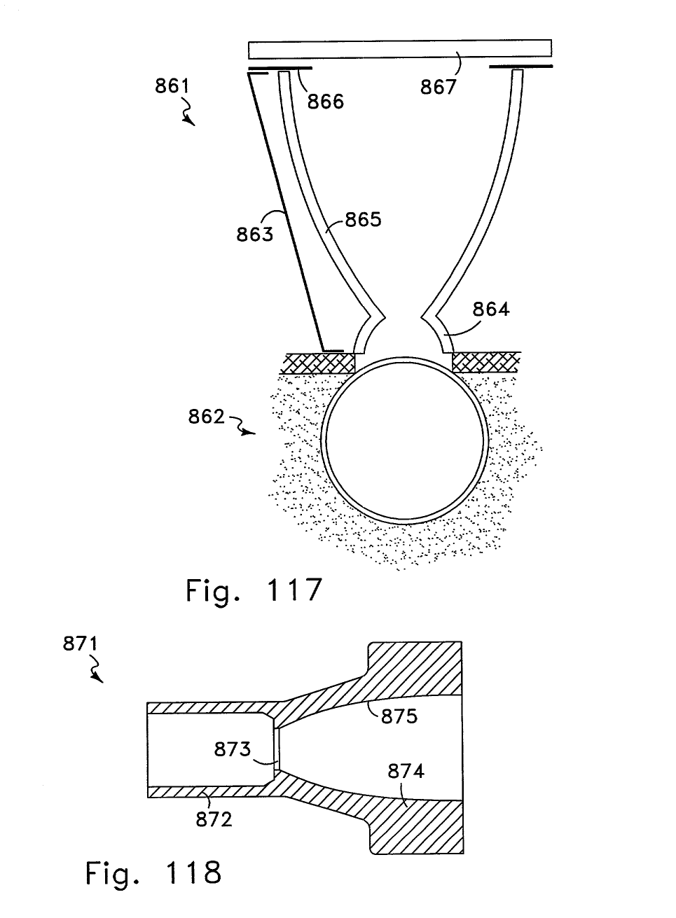

With reference to FIG. 117, a lamp system 861 includes an aperture lamp 862 and an optical element 863 aligned with the output window of the aperture lamp 862. The optical element 863 includes serial CPCs 864 and 865, which are preferably hollow and preferably made from one-piece. The first CPC 864 is adapted to return high angle light back through the output window of the aperture lamp 862 (e.g. for recycling). The second CPC 865 is adapted to transform light from the first CPC 864 into a desired output angle. The CPCs may be made of an IR transmissive material such as quartz or Pyrex glass (e.g. molded or ground to the desired shape) and coated with a visible light reflective coating such that much or most of the IR radiation is transmitted through the walls of the optical element while the visible light is reflected. Where the light output from the aperture lamp 862 is sufficiently uniform, the present structure eliminates the light integrator found in many projection systems. The serials CPCs of the optical element 863 provide a compact structure which produces near telecentric light of a near lambertian angular distribution as well as highly uniform spatial distribution over the image gate. With suitably reflective surfaces, the system is efficient both in terms of light transmission and etendue. The lamp system may include further components such as a remote aperture 866 and filters 867 (e.g. a UV light filter and/or and IR light filter).

With reference to FIG. 118, a lamp component 871 includes an integrated aperture cup 872 and optical element 874 made from a single piece of ceramic material (e.g. boron nitride, alumina, silica). As illustrated the optical component comprises a CPC 874. The component 871 advantageously has the output window 873 of the aperture cup 872 and the entrance window of the CPC 874 precisely aligned. Moreover, there is no light loss or etendue growth at the junction of the cup 872 and the CPC 874. Assembly is simplified by the integration of the two pieces. Used in conjunction with a remote aperture, the highly integrated structure provides efficient light recycling. The one-piece aperture cup and CPC can be pressed, molded, or machined. If necessary or desirable, a dichroic coating may be disposed on the interior surface 875 of the CPC 874 to provide a desired reflectivity.

With reference to FIG. 119, a lamp system includes an aperture lamp 881 which directs light through an optics tube 882 and a conductive screen 883 positioned between the lamp 881 and the optics tube 882. The screen 883 decreases the electromagnetic interference (EMI) which may be emitted from the lamp 881. With lamps of the type which include a small opening for emitting light therefrom (e.g. such as aperture lamp 881), the entire lamp housing is readily sealed from EMI except for the light emitting aperture. In general, the aperture may be small enough so as to be below cutoff for the frequency of the lamp. However, for added margin for EMI suppression, as secondary shield may be desirable. As illustrated, the screen may be a metallic mesh having a mesh spacing selected in relation to the radiating wavelength and also to be as open as possible to not substantially block the light output. Alternatively, the screen may be made from indium titanium oxide (ITO) glass or like.

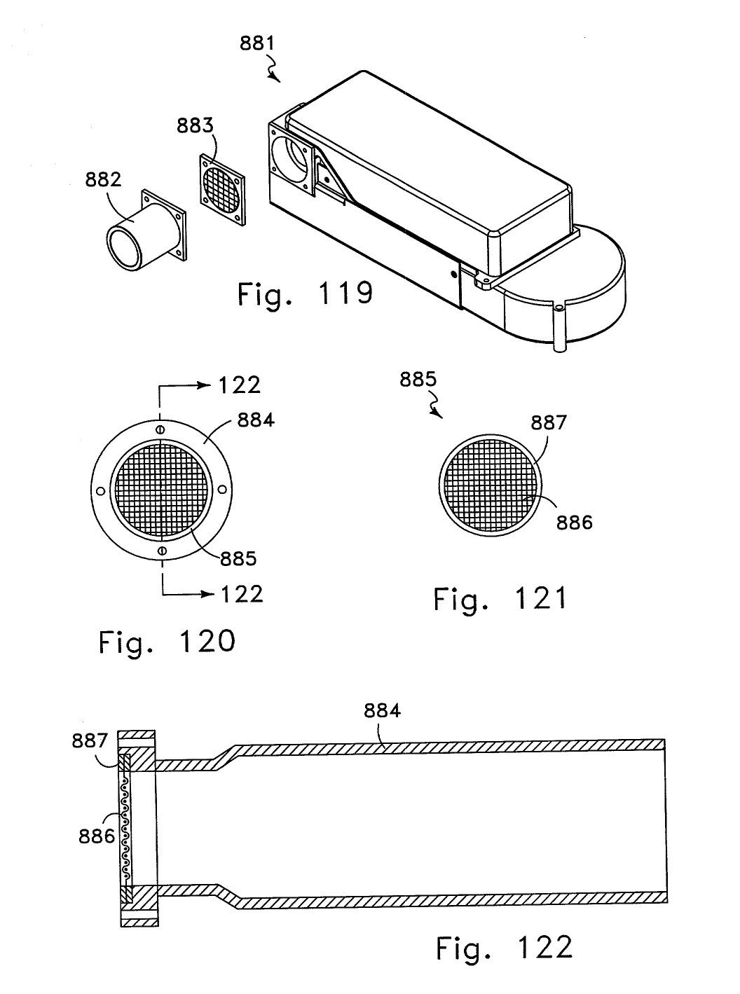

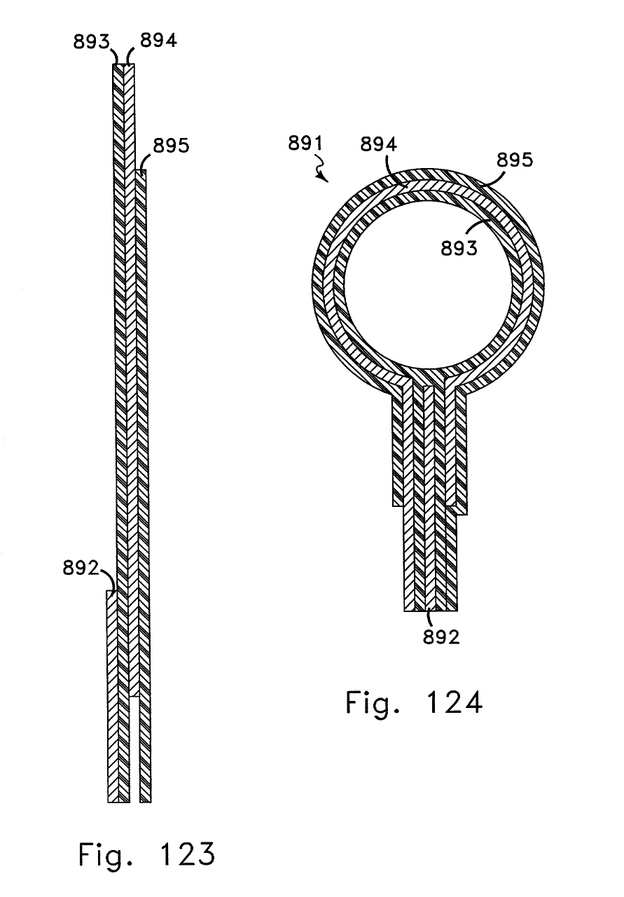

With reference to FIGS. 120-122, an optics tube 884 has a base which defines a recessed portion adapted to receive a circular disc. A circular conductive RF screen 885 is made from a metallic mesh sandwiched between two metallic (e.g. copper) rings which provide good electrical contact and rigidity. The screen 885 is disposed in the recessed portion of the optics tube 885.

With reference to FIGS. 123-124, a LTCC structure 891 provides a wedding ring shaped excitation coil. The structure 891 is fabricated using LTCC material and silver stenciling processes to provide an excitation coil which is completely encased in ceramic material. Layers 892 and 894 are conductive materials (e.g. silver stencil) while layers 893 and 895 are ceramic materials (e.g. DuPont 951 or 953). FIG. 123 shows the laminated structure and FIG. 124 shows the structure 891 after being formed into the coil shape.

Advantageously, the encased coil does not oxidize, even under high operating temperatures of the lamp. Also, the high voltage component of the lamp head structure is completely encased, thereby reducing arcing and corona problems. The capacitor stack (e.g. the high voltage capacitor and the low voltage capacitor) and the coil are formed by a lamination and stenciling process, providing a potentially lower cost manufacturing process that can be automated.

With suitable components and circuitry, the lamps described herein can operate in the range of 400 MHz, 700 MHz, or 900 MHz at power levels ranging from 50 to 200 RF watts. Light output is in excess of several thousands lumens emitting from a small aperture area, thereby providing a high brightness lamp. Appropriately configured, start and re-strike times are generally under ten seconds. Although many of the CPCs illustrated herein are solid, hollow CPCs may be used. Other useful optical arrangements are described in PCT Publication No. WO 01/27962, which is incorporated herein by reference in its entirety. With appropriate thermal management of the lamp components, it is expected that the lamp has a long useful life with high lumen maintenance.

While the invention has been described in connection with what is presently considered to be the preferred examples, it is to be understood that the invention is not limited to the disclosed examples, but on the contrary, is intended to cover various modifications and equivalent arrangements included within the spirit and scope of the inventions.

What is claimed is:

1. An integrated high brightness electrodeless lamp, comprising:
a lamp base defining two or more compartments housing components of the lamp, the lamp components comprising:
an RF source providing RF energy for the lamp;
an aperture bulb assembly including an electrodeless envelope containing a discharge forming fill which emits light when excited by RF energy; and
an excitation structure for coupling RF energy from the RF source to the discharge forming fill;
wherein at least one compartment provides an opening in the lamp base;
a cover fitted to the lamp base; and
an optics assembly positioned in the opening in the lamp base, wherein the lamp base, the cover, and the optics assembly provide an RF sealed system.

2. The lamp as recited in claim 1, wherein the optics assembly is removably mounted in the opening in the lamp base.

3. The lamp as recited in claim 2, wherein the optics assembly is mounted in the opening in the lamp base with a twist lock mounting structure.

4. The lamp as recited in claim 1, wherein the RF source comprises a power oscillator operating at a frequency which can be tuned over a range of frequencies and a control circuit connected to the power oscillator and adapted to adjust the frequency of the power oscillator, wherein the power oscillator is manufactured on a first printed circuit board having pads on one surface of the board for connecting to the control circuit, and the control circuit is manufactured on a second printed circuit board which is electrically and mechanically connected to the first printed circuit board on the surface of the first board having the pads for connecting to the control circuit.

5. The lamp as recited in claim 1, wherein the RF source comprises a control circuit for controlling an operation of the RF source, and wherein the control circuit is adapted to control the RF source in at least three stages including a coarse stage during initial starting followed by a medium stage until the RF source is determined to be well matched followed by a fine stage for optimizing operation of the RF source.

6. The lamp as recited in claim 1, wherein the RF source comprises a control circuit for adjusting an operating frequency of the RF source and wherein the control circuit is adapted to initially adjust the frequency to reduce reflected power below a first pre-determined threshold and thereafter to adjust the frequency to increase forward power while maintaining reflected power below a second pre-determined threshold.

7. The lamp as recited in claim 1, wherein the RF source comprises a power oscillator operating at a frequency which can varied over a range by a tuning circuit, and wherein the tuning circuit comprises a pair of complementary varactor diodes.

8. The lamp as recited in claim 1, wherein the lamp base has an outer surface which is contoured to mate with a folded fin heatsink.

9. The lamp as recited in claim 1, wherein the RF source comprises a power oscillator operating at a frequency of greater than 500 MHz with an active device having multiple transistor die in a single package with all of the die connected on respective inputs of the die to a single input leadframe and with all of the die connected on respective outputs of the die to a single output leadframe.

10. The lamp as recited in claim 1, wherein the excitation structure comprises a wedding ring coil and wherein a block of ceramic material is positioned in the throat of the coil.

11. A solid state oscillator, comprising:
a solid state active element having an input and an output;
a feedback network connected between the input and the output of the active element, the feedback network being adapted to provide suitable gain and phase shift to initiate and sustain an oscillating condition at an operating frequency; and
a tuning circuit connected to the feedback network, the tuning circuit being adapted to adjust the operating frequency and comprising a pair of complementary varactor diodes.

12. A solid state oscillator, comprising:
a solid state active element having an input and an output; and
a feedback network connected between the input and the output of the active element, the feedback network being adapted to provide suitable gain and phase shift to initiate and sustain an oscillating condition at an operating frequency of greater than 500 MHz,
wherein the solid state active element comprises at least two die in a single package with all of the die connected on respective inputs of the die to a single input leadframe and with all of the die connected on respective output of the die to a single output leadframe.
